(19) United States
(12) Patent Application Publication
(10) Pub. No.: US 2019/0102720 A1
(43) Pub. Date: Apr. 4, 2019

(54) JOB-TRANSITION ANALYSIS AND REPORT SYSTEM

(71) Applicant: Microsoft Technology Licensing, LLC, Redmond, WA (US)

(72) Inventors: Michael Jennings, San Francisco, CA (US); Timothy Vergara Santos, Milpitas, CA (US); Ted Tomlinson, Oakland, CA (US)

(21) Appl. No.: 15/797,987

(22) Filed: Oct. 30, 2017

Related U.S. Application Data
(60) Provisional application No. 62/566,364, filed on Sep. 30, 2017.

(51) Int. Cl. G06Q 10/06; G06Q 10/10; G06F 17/30; G06Q 50/00

(52) U.S. Cl. CPC G06Q 10/06393; G06Q 50/01; G06F 17/30867; G06Q 10/1053

(57) ABSTRACT

Methods, systems, and computer programs are presented for analyzing and generating employee-mobility information. One method includes an operation for determining transitions of users of a social network based on user profiles. Each transition includes a change of employment. Further, the method includes creating a member table based on the determined transitions and the user profiles. The member table includes fields for a company identifier and a previous company identifier, where the previous company identifier indicates a transition from the source company that is associated with the previous company identifier to the destination company that is associated with the company identifier. The method further includes operations for providing a user interface for receiving user input to create a report based on the determined transitions, accessing the member table to generate report data based on the received user input, and for causing presentation of the report based on the report data.

### CLAIM OF PRIORITY

This application claims priority from U.S. Provisional Patent Application No. 62/566,364, filed Sep. 30, 2017, and entitled “Employer Ranking for Inter-Company Employee Flow.” This provisional application is herein incorporated by reference in its entirety.

### TECHNICAL FIELD

The subject matter disclosed herein generally relates to methods, systems, and programs for analyzing company performance in regard to hiring and employee retention.

### BACKGROUND

Employment market data is very important for fast growing companies because these companies want to understand employment-related data, such as what the population is for a given skill set, where potential employees are located, what the typical compensation is, whether people for a certain skill are changing jobs often, etc. Further, a good understanding of the labor market may assist a company deciding where to establish a new site because the company may choose a site with a readily-available workforce.

However, employment data is usually kept secret by most companies, which merely provide, sometimes, the number of employees of the company. Therefore, getting a thorough understanding of the labor market based on available skills and geography is a difficult task.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIG. 2 is a screenshot of a user's profile, according to some example embodiments.

FIG. 3 illustrates data structures for storing job and member information, according to some example embodiments.

FIG. 4A is an architecture of a system for creating and analyzing talent flow information, according to some example embodiments.

FIG. 4B illustrates the generation of the talent tables, according to some example embodiments.

FIG. 5 illustrates a member positions table for storing transition data, according to some example embodiments.

FIG. 6 illustrates a member profile table for storing transition data by user, according to some example embodiments.

FIG. 7 illustrates a report for talent flow over time and related queries, according to some example embodiments.

FIG. 8 illustrates a table for workforce distribution by function and related queries, according to some example embodiments.

FIG. 9 is a talent geographic map, according to some example embodiments.

FIG. 10 illustrates sample queries for the talent location distribution, according to some example embodiments.

FIG. 11 is a report for talent flow between companies, according to some example embodiments.

FIG. 12 is a timeline for hires and departures of a given company, according to some example embodiments.

FIG. 13 is a report for head-to-head comparison of talent flow between two companies, according to some example embodiments.

FIG. 14 illustrates some of the filtering possibilities for report generation, according to some example embodiments.

FIG. 15 is a flowchart of a method, according to some example embodiments, for analyzing and generating employee mobility information.

FIG. 16 is a report representing employee inflow over time for a plurality of companies, before smoothing, according to some example embodiments.

FIG. 17 is a report representing employee inflow over time for a plurality of companies after smoothing, according to some example embodiments.

FIG. 18 is a talent pool report, according to some example embodiments.

FIG. 19 is a talent-distribution report by company, according to some example embodiments.

FIG. 20 is a talent report by educational institution, according to some example embodiments.

FIG. 21 is a talent report by user skill, according to some example embodiments.

FIG. 22 is a workforce-distribution report for a company, according to some example embodiments.

FIG. 23 is a company report by function, according to some example embodiments.

FIG. 24 is a block diagram illustrating a representative software architecture, which may be used in conjunction with various hardware architectures herein described.

FIG. 25 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods, systems, and computer programs are directed to analyzing and generating employee mobility information. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The data from a social network is utilized to identify labor market parameters. The social network allows users to enter their job history into their profile, including jobs held, dates for the jobs, and job titles. This job history is used to identify job transitions for the users, and these job transitions are used to identify user-employment data, such as company headcount over time, migrations between companies (e.g., number of users that went from one company to another in a given quarter), attrition by function, geographic location of employees with desired skills, and so forth. The data is analyzed to provide employment reports based on user job transitions. The reporting tool helps talent-acquisition professionals understand labor market trends, identify talent pools, and understand how talent flows to and from companies.

In one embodiment, a method includes an operation for determining transitions of users of a social network based on user profiles stored in a social network database. Each transition comprises a change of employment from a source company to a destination company. Further, the method includes an operation for creating a member positions table based on the determined transitions and the user profiles. The member positions table includes a first field for a company identifier and a second field for a previous company identifier, where the previous company identifier indicates a transition from the source company that is associated with the previous company identifier to the destination company that is associated with the company identifier. Additionally, the method includes operations for providing a user interface for receiving user input to create a report based on the determined transitions, and for accessing the member positions table to generate report data based on the received user input. Further, the method includes an operation for causing presentation of the report based on the report data.

In one embodiment, a method includes an operation for identifying a transition of member of a social network from a source company to a destination company based on a profile of the member. The transition is determined by identifying that employment at the destination company follows employment at the source company. Further, the method includes adding a row to a member positions table for the identified transition. The member positions table includes a row for each position of the members of the social network, and the member positions table includes a first field for a company identifier and a second field for a previous company identifier, where the previous company identifier indicates a transition from the source company that is associated with the previous company identifier to the destination company that is associated with the company identifier. The method further includes an operation for receiving, via a user interface, a request for a report related to user transitions, and an operation for querying the member positions table to identify transitions based on a value of the previous company identifier. Additionally, the method includes operations for generating the report based on a response to the query, and for causing presentation of the report based on the report data.

In another embodiment, a system includes a memory comprising instructions and one or more computer processors. The instructions, when executed by the one or more computer processors, cause the one or more computer processors to perform operations comprising: determining transitions of users of a social network based on user profiles stored in a social network database, each transition comprising a change of employment from a source company to a destination company; creating a member positions table based on the determined transitions and the user profiles, the member positions table including a first field for a company identifier and a second field for a previous company identifier, wherein the previous company identifier indicates a transition from the source company that is associated with the previous company identifier to the destination company that is associated with the company identifier; providing a user interface for receiving user input to create a report based on the determined transitions; accessing the member positions table to generate report data based on the received user input; and causing presentation of the report based on the report data.

In yet another embodiment, a non-transitory machine-readable storage medium includes instructions that, when executed by a machine, cause the machine to perform operations comprising: determining transitions of users of a social network based on user profiles stored in a social network database, each transition comprising a change of employment from a source company to a destination company; creating a member positions table based on the determined transitions and the user profiles, the member positions table including a first field for a company identifier and a second field for a previous company identifier, wherein the previous company identifier indicates a transition from the source company that is associated with the previous company identifier to the destination company that is associated with the company identifier; providing a user interface for receiving user input to create a report based on the determined transitions; accessing the member positions table to generate report data based on the received user input; and causing presentation of the report based on the report data.

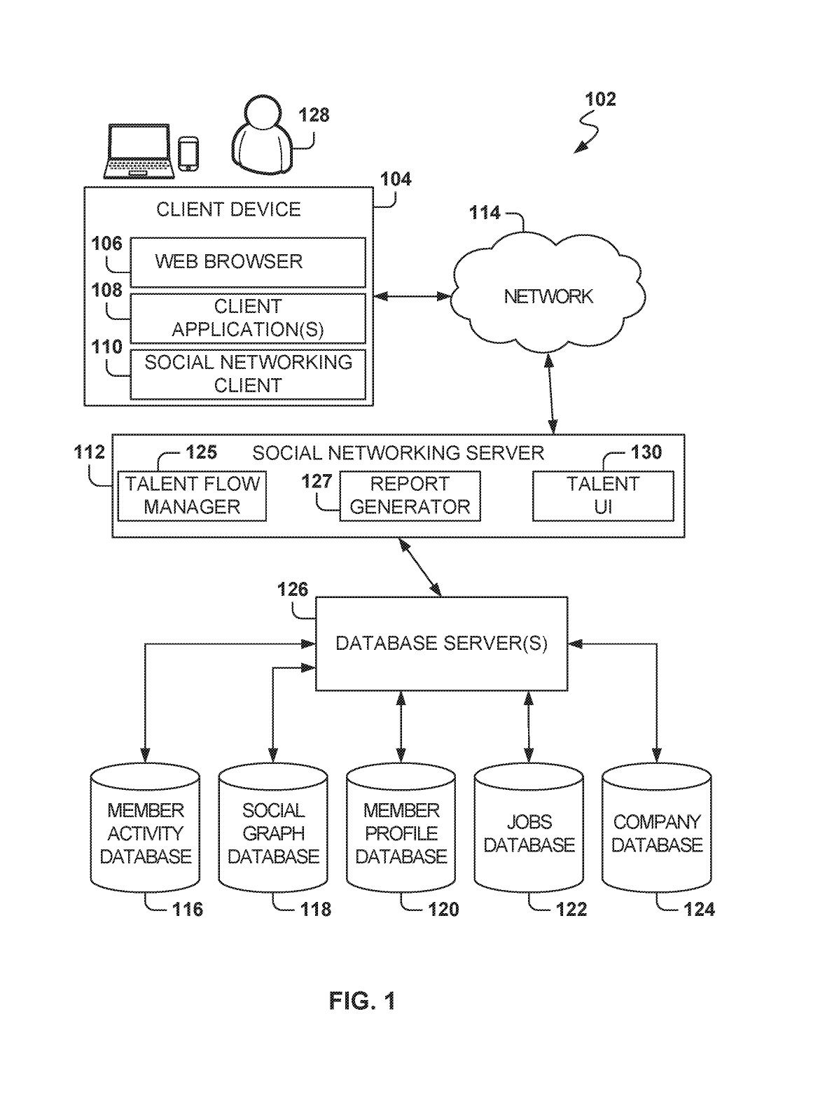

FIG. 1 is a block diagram illustrating a networked system, according to some example embodiments, including a social networking server 112, illustrating an example embodiment of a high-level client-server-based network architecture 102. The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 128, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a jobs database 122, and a company database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member; however, some companies may not be members of the social network even though some of the employees of the company may be members of the social network. The company database 124 includes company information, such as name, industry, contact information, website, address, location, geographic scope, and the like.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, posting job suggestions for the members, searching job posts, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124. For example, and without limitation, such interfaces and/or services may include one or more Application Programming Interfaces (APIs), one or more services provided via a Service-Oriented Architecture (SOA), one or more services provided via a Representational State Transfer (REST)-Oriented Architecture (ROA), or combinations thereof. In an alternative embodiment, the social networking server 112 communicates with the databases 116-124 and includes a database client, engine, and/or module, for providing data to, modifying data stored within, and/or retrieving data from the one or more databases 116-124.

While the database server(s) 126 is illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

The social networking server 112 includes, among other modules, a talent flow manager 125, a report generator 127, and a talent user interface 130. The talent flow manager 125 identifies the employee transitions and makes tables for easy access to talent flow data, as described in more detail below. The report generator 127 generates the reports associated with the company scores and talent migrations, and the talent user interface 130 provides an interface for accessing the reports and options for the report generation.

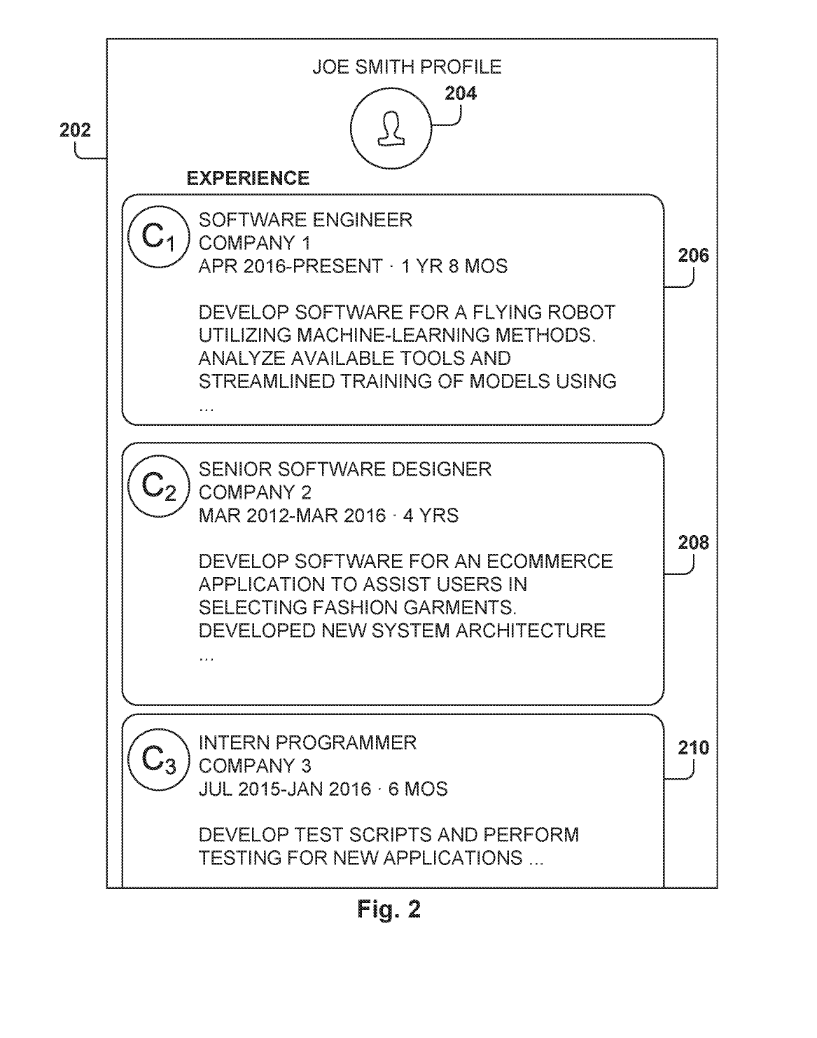

FIG. 2 is a screenshot 202 of a user's profile, according to some example embodiments. In the example embodiment of FIG. 2, the user's profile includes several jobs held by the user 204, in similar format to a generic resume.

In one example embodiment, each job (206, 208, 210) includes a company logo for the employer (e.g., C₁), a title (e.g., software engineer), the name of the employer (e.g., Company 1), dates of employment, and a description of the job tasks or job responsibilities of the user 204.

When users change jobs, the users tend to update their employment history, although updating may not happen right away. By analyzing the job changes, including end date and start dates, it is possible to identify transitions between companies.

In the exemplary embodiment of FIG. 2, it is observed that the job 208 as a senior software designer in Company 2 ended in March 2016, and the job 206 as a software engineer in Company 1 started on April 2016. Since the dates are close in time and the job titles are similar, it can be determined that the user transitioned from Company 1 to Company 2 in April 2016. In other example embodiments, the transition dates may be inferred by making inferences based on other data, besides the data in the user profile.

The social network analyzes the transitions for the users within the social network and aggregates this transitional data to generate reports based on employee migrations between companies, job titles, job skills, time intervals, etc.

In some example embodiments, the information on the user profiles may be categorized. For example, the company may include a company ID, a title may be assigned a title ID (where the title is standardized to cover a plurality of similar job titles), and a position may be assigned a position ID. In some example embodiments, each job (member_position) of the user may be described utilizing a record with one or more of the following fields: {member_id: int, position_id: int, company_id: int, is_current: boolean (indicating if this is believed to be the user's current job), industry_id: int, position_start_time: long, position_end_time: long}. Other embodiments may include additional fields or fewer fields.

In some embodiments, restricted member profiles are filtered out before storing into the Pinot store. Restricted member profiles are defined as accounts with special restrictions, such as accounts that have been login or spam restricted on the site. The restrictions may occur for a variety of reasons: fake account, spamming, scraping, compromised account, etc.

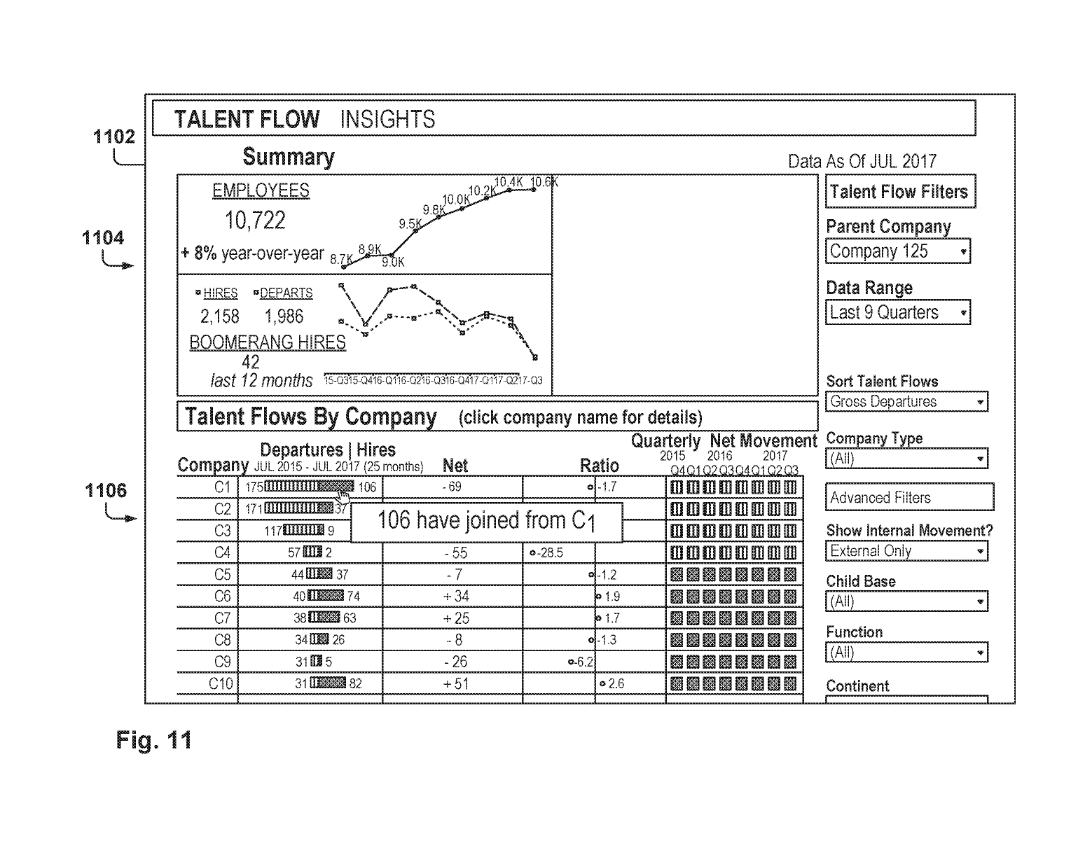

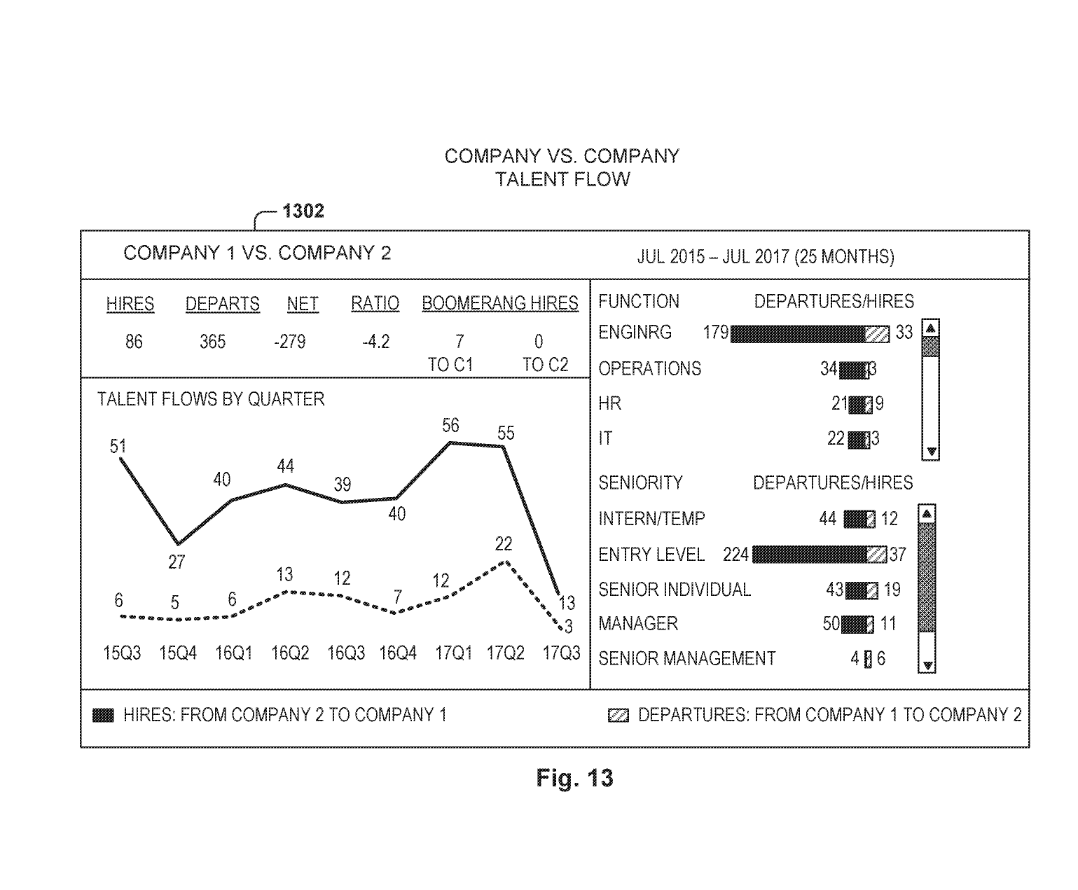

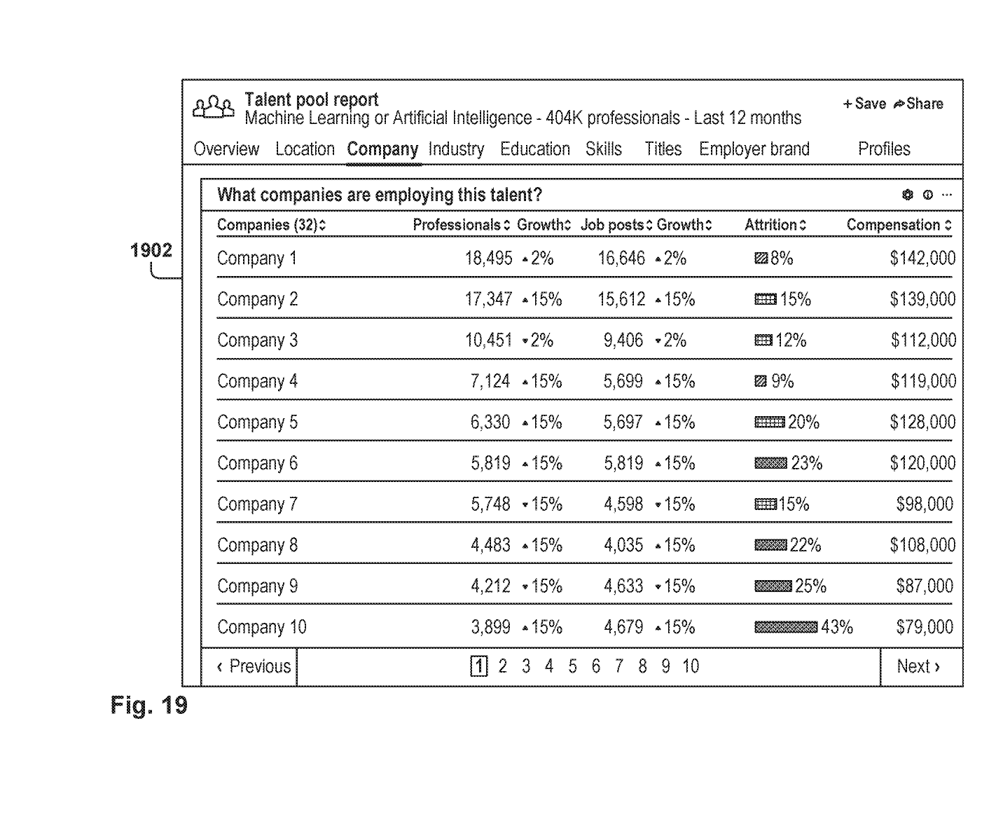

The talent flow analysis may be performed to obtain information regarding migrations between companies (e.g., FIG. 11) and to obtain information regarding migrations between companies for employees with specific skills (e.g., data scientists) (e.g., FIGS. 13 and 19).

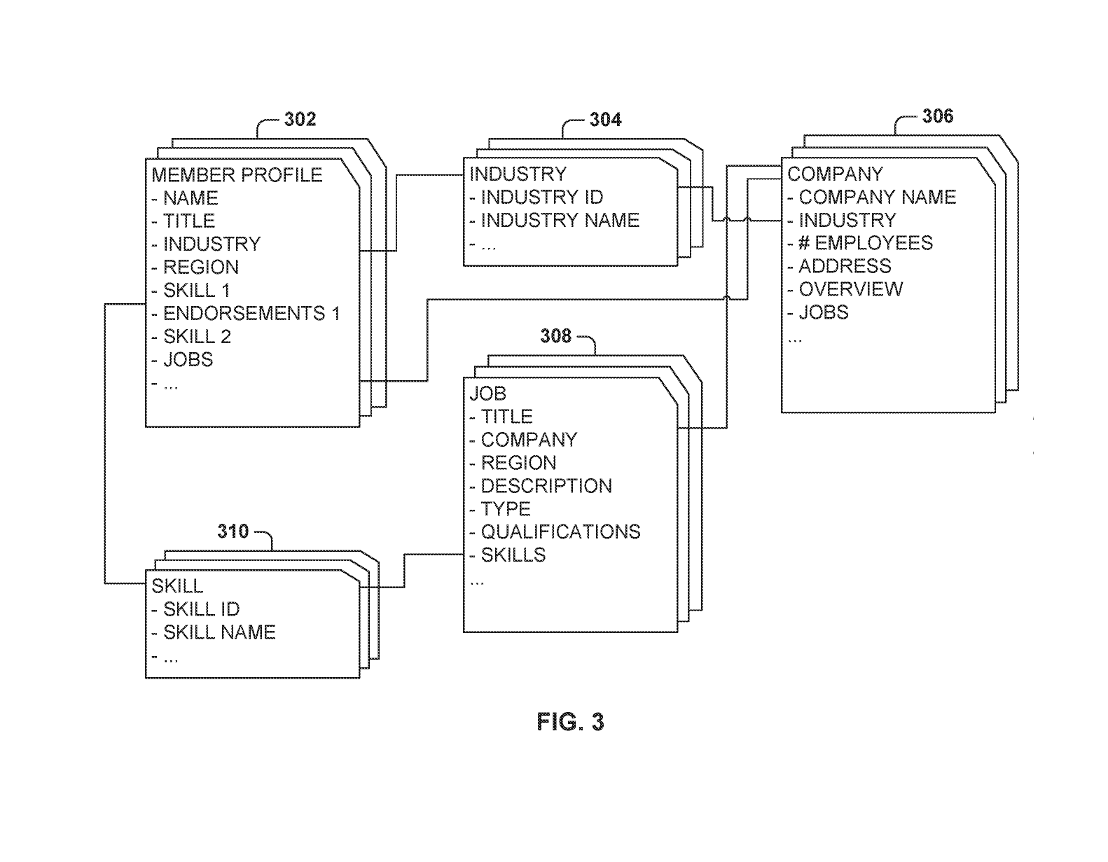

FIG. 3 illustrates data structures for storing job and member information, according to some example embodiments. Each user in the social network has a member profile 302, which includes information about the user. The member profile 302 is configurable by the user and includes information based on the user activity in the social network (e.g., likes, posts read).

In one example embodiment, the member profile 302 may include information in several categories, such as experience, education, skills and endorsements, accomplishments, contact information, following, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the account is associated with the number of endorsements received for each skill from other members.

The member profile 302 includes member information, such as name, title (e.g., job title), industry (e.g., legal services), geographic region, jobs, skills and endorsements, and so forth. In some example embodiments, the member profile 302 also includes job-related data, such as employment history, jobs previously applied to, or jobs already suggested to the member (and how many times the job has been suggested to the member). Within member profile 302, the skill information is linked to skill data 310, the employer information is linked to company data 306, and the industry information is linked to industry data 304.

The experience information includes information related to the professional experience of the user. In one example embodiment, the experience information includes industry data 304, which identifies the industry in which the user works. In one example embodiment, the user is given an option to select an industry from a plurality of industries when entering this value in the profile. In other example embodiments, the user may also enter an industry that is not in the list of predefined industries. In some example embodiments, the industry is defined at a high level. Some examples of industries configurable in the member profile include information technology, mechanical engineering, marketing, and the like. The experience information area may also include information about the current job and previous jobs held by the user.

The skill data 310 and endorsements includes information about professional skills that the user has identified as having been acquired by the user, and endorsements entered by other users of the social network supporting the skills of the user. Accomplishments include accomplishments entered by the user, and contact information includes contact information for the user, such as email and phone number.

The industry data 304 is a table for storing the industries identified in the social network. In one example embodiment, the industry data 304 includes an industry identifier (e.g., a numerical value or a text string), and an industry name, which is a text string associated with the industry (e.g., legal services).

In one example embodiment, the company data 306 includes company information, such as company name, industry associated with the company, number of employees, address, overview description of the company, job postings, and the like. In some example embodiments, the industry is linked to the industry data 304.

The skill data 310 is a table for storing the different skills identified in the social network. In one example embodiment, the skill data 310 includes a skill identifier (ID) (e.g., a numerical value or a text string) and a name for the skill. The skill identifier may be linked to the member profile 302 and job data 308.

In one example embodiment, job data 308 includes data for jobs posted by companies in the social network. The job data 308 includes one or more of a title associated with the job (e.g., software developer), a company that posted the job, a geographic region for the job, a description of the job, a type of job, qualifications required for the job, and one or more skills. The job data 308 may be linked to the company data 306 and the skill data 310.

It is noted that the embodiments illustrated in FIG. 3 are examples and do not describe every possible embodiment. Other embodiments may utilize different data structures, fewer data structures, combine the information from two data structures into one, add additional or fewer links among the data structures, and the like. The embodiments illustrated in FIG. 3 should therefore not be interpreted to be exclusive or limiting, but rather illustrative.

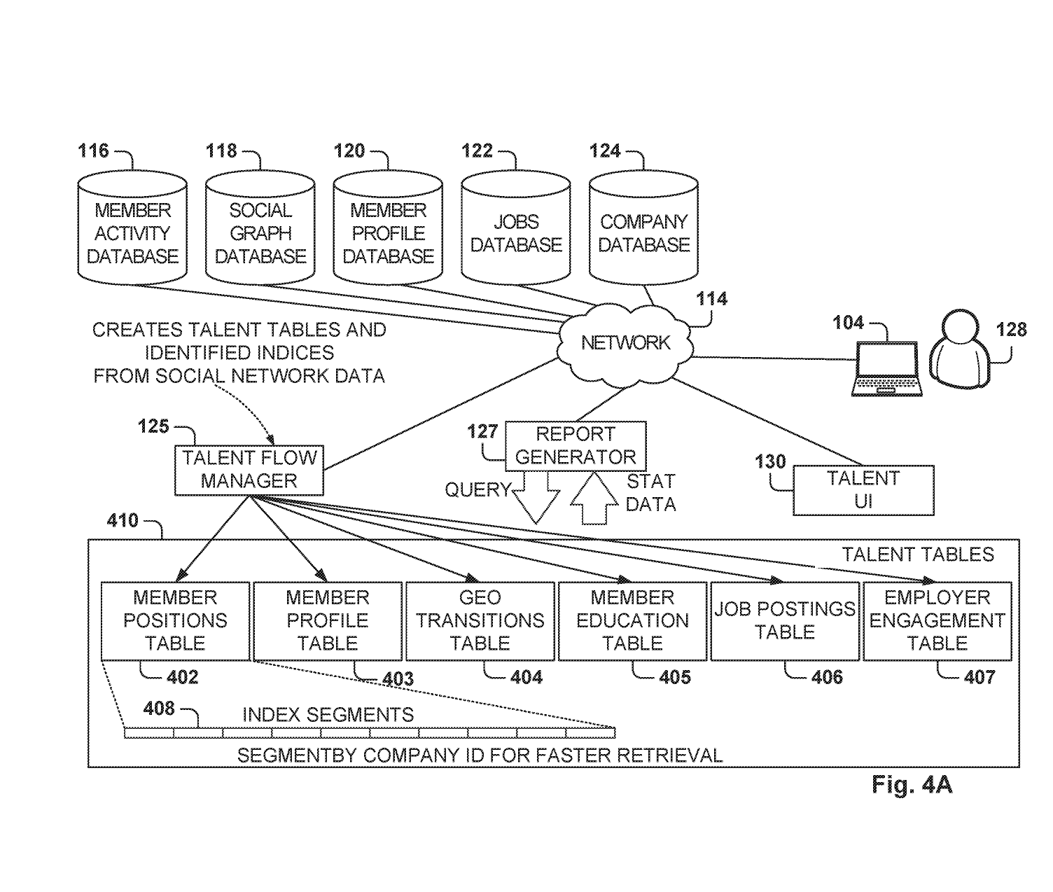

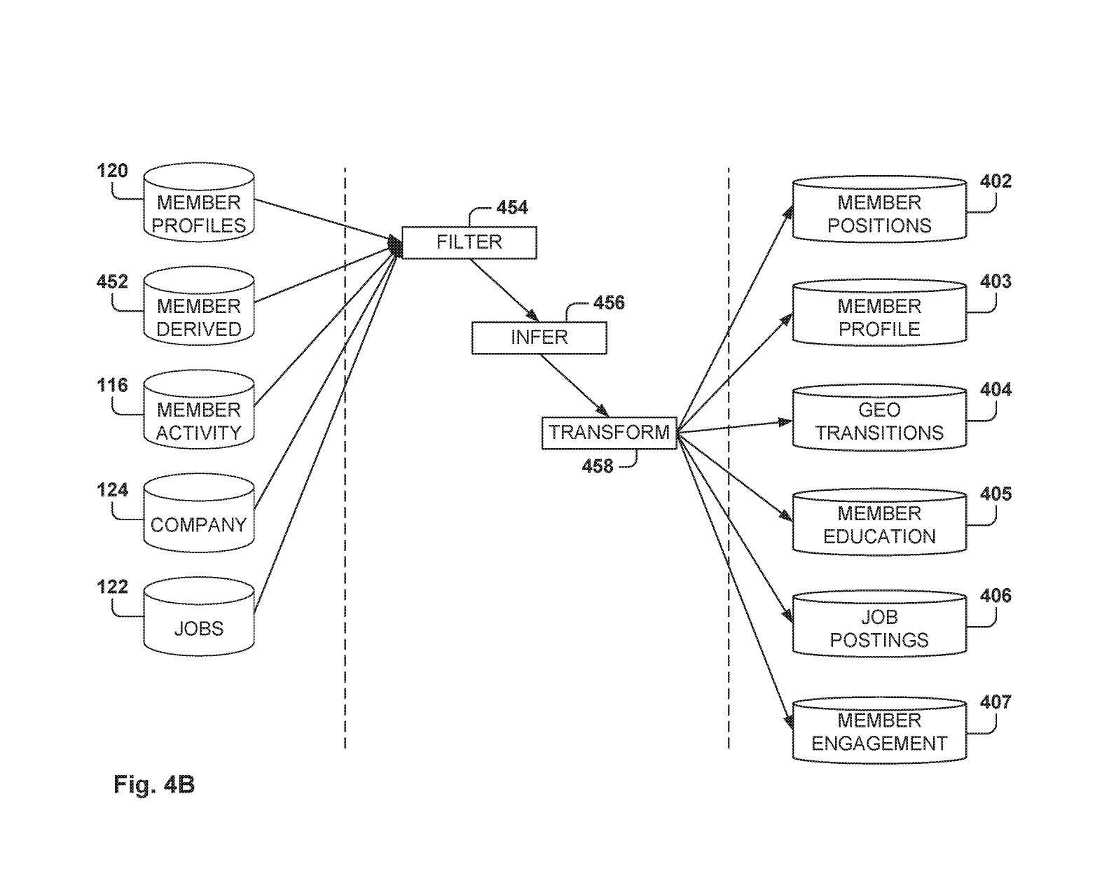

FIG. 4A is an architecture of a system for creating and analyzing talent flow information, according to some example embodiments. The talent flow manager 125 accesses the social network databases to create talent tables 410 that re-structure talent-related data in order to simplify and accelerate query processing for generating talent reports.

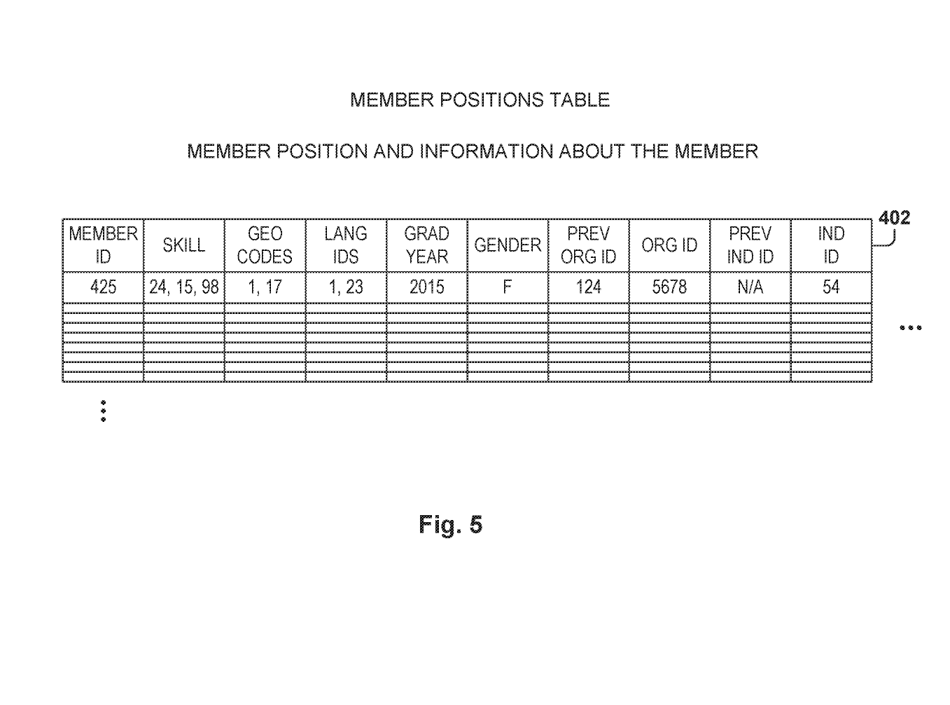

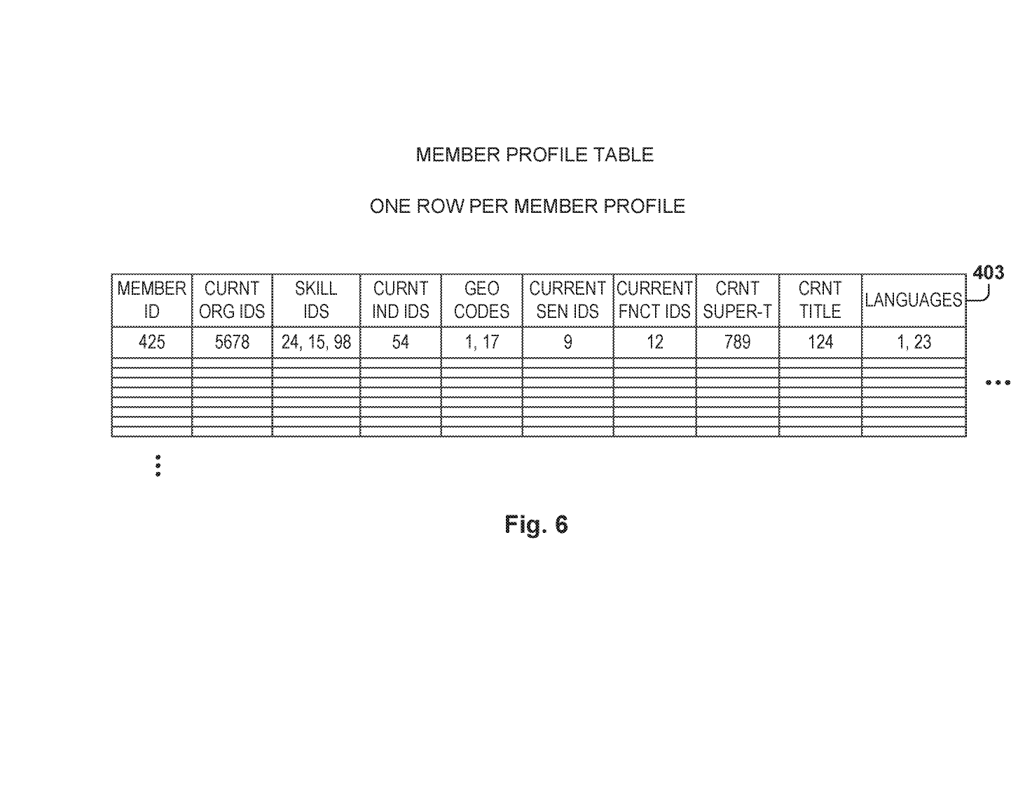

In some example embodiments, the talent tables 410 include a member positions table 402, a member profile table 403, a geographic transitions table 404, a member education table 405, a job postings table 406, and an employer engagement table 407. Details about the talent tables 410 are provided below with reference to FIGS. 5 and 6.

The talent user interface 130 provides the user interface for the user 128, such as a user interface presented on device 104. The talent user interface 130 provides options for configuring the talent flow manager 125, managing the tables data, and generating talent-related reports.

The report generator 127 generates queries based on the user requests, the queries being for one or more of the talent tables 410, and the talent tables 410 return statistical data for generating the reports. The report generator 127, together with the talent user interface 130, presents the reports to the user 128 on device 104.

The generated reports are valuable because they can present information previously unavailable, such as information regarding employee growth rates, attrition rates, transfer of employees between companies, geographic locations of desired-skills employees, etc. It is noted that most companies do not announce this level of detail for their employees. But by analyzing the social network data, it is possible to get detailed employee statistical data, and because of the data architecture, it is possible to get these reports in real time, without having to scan all the data in the social network every time a report is requested, which could take minutes, hours, or even days.

For example, for a startup company that is not public yet, and that may be operating in “stealth” mode (e.g., sharing little information with the community), it is possible to start finding out that the company is attracting certain type of skills, high-talent workers, growing the employee base at the rapid growth, hiring engineers in some cities and salespeople in other cities, etc. For a financial investor and for a competitor, this type of information may be invaluable since no other financial data may be available to assess the company.

The talent tables 410 summarize talent-related information for quick and easy access to talent data. The data in the talent tables 410 may be used to synthesize employment data, including transitions of employees between companies, attrition rates, employee growth over time, etc. Several samples of reports are discussed below.

The talent flow manager 125 performs complex operations to transform the data available in the social network databases, such as by performing joins and combining data from multiple sources in order to structure the member's information in a way that facilitates quick access to talent-flow reports.

In some example embodiments, the data for the talent tables 410 is divided into index segments 408, but other embodiments may not divide the data into index segments. An index segment of the database is created to include all the information about a company, or all the information about a plurality of companies. With index segments 408, generating a report for a company means accessing the data of the index segment associated with that company, and not having to search for data in the whole table. For example, all the information about positions in a certain company are located within the same index segment. It is noted that the data from an index segment may be distributed over one or more data servers.

Partitioning and sorting across Pinot segments increases performance because a large portion of reports are related to a company. For example, the manager of the company may be interested in statistical information about his company or how his company numbers compare to other companies. Since this information is kept in the same Pinot server, the data may be generated very quickly.

Since a member may transition between a company associated with an index segment to another company in another index segment, the data for this job transition may be duplicated in the two index segments. Therefore, the data from the different index segments may overlap.

In some example embodiments, the talent tables 410 are stored in respective Pinot databases. Pinot is a real-time, distributed OLAP (Online Analytical Processing) datastore, used to deliver scalable real-time analytics with low latency. A Pinot database can ingest data from online data sources (such as the social network databases) as well as offline sources. Pinot is well suited for analytical use cases on immutable, append-only data that require low latency between an event being ingested and it being available to be queried.

The Pinot database is column-oriented with various compression schemes (e.g., Run Length and Fixed Bit Length) and uses pluggable indexing technologies (e.g., Sorted Index, Bitmap Index, and Inverted Index). The Pinot database is designed to optimize a query/execution plan based on query and segment metadata, and supports SQL-like language that supports selection, aggregation, filtering, group by, order by, distinct queries on fact data. Further, the Pinot database includes support for multivalued fields (e.g., lists of values) and is horizontally scalable and fault tolerant. Due to its design, the Pinot database does not support queries that span across multiple tables, so the query may be performed for just one table (e.g., no joins). However, this limitation is easily overcome by combining data from two tables (if needed) by copying data indexed by certain fields, such as company identifier or member identifier.

In some example embodiments, the talent tables 410 are updated once a day, but other periods are also possible, such as periods ranging from a few hours to several weeks. Members do not update their profiles right after they change jobs, so new information may be added by the members at any time. This is why updating the talent tables 410 daily ensures that the best possible information is available.

One of the properties of the Pinot database is that all the data is contained within one table, which means that it is not possible to join tables, as in regular SQL tables. This is why additional information is added into some tables to be able to get data quickly. For example, the member positions table 402, described in more detail below with reference to FIG. 5, includes information about transitions and also information about the skills of the members involved in those transitions. This way, it is possible to create data regarding transitions linked to user's data (e.g., getting a report related to transitions of employees that possess a certain skill).

In some example embodiments, the talent tables 410 are separate tables, and it is not necessary to interact or correlate the information from multiple tables to generate reports. This is why some of the information may be duplicated across the different tables. In some cases, having duplicate information does not require much extra processing, since all that is required is to simply copy data from one table to another.

The report generator 127 processes the queries to get the information. In some example embodiment, a REST API is used to interface with a server for the talent tables 410 (e.g., the talent flow manager 125 or a separate dedicated server for the talent tables databases).

FIG. 4B illustrates the generation of the talent tables, according to some example embodiments. FIG. 4B illustrates the generation of optimized analytics stores in servers for real time interactive analysis from the source data in the social network.

The source data includes both primary data entered directly by the member and derived data inferred via machine learning systems from the data, network graph, and user activities on the social network.

The source data may be processed in a variety of architectures before being loaded into the analytics data storage. These processes include nearline processes via a message bus (e.g., like Kafka) and offline processes from distributed file system like HDFS using a framework like MapReduce or in-memory graph processing like Spark. In some example embodiments, implementations leverage Spark with input data sets from HDFS and publish the output data to the analytics store in a bulk load process.

The process that converts the data from input data stores to the analytical data store may apply a number of modifications to the data. Some examples include:
Filtering 454 some of the data or attributes. The filtering may help improve the accuracy, speed, and scalability of the analytics system. In some examples, the restricted-member data may be filtered.
Inferring 456 additional attributes for a record. For example, to infer a missing attribute of a member position, such as the start date.
Joining multiple records together. For example, to combine data from a member profile and a company profile into a single analytics store. This may be used to enable faster queries based on data from multiple sources (e.g., filter members by company size).
Transforming 458 an attribute from one dimension or type to another.
Generating new attributes based on the input data. This may be used for time dimensions and categorical attributes. For example, a timestamp may be used to generate an attribute for the quarter or month associated with a piece of data so that values can be quickly grouped in the analytics store by those larger time spans.

FIG. 5 illustrates a member positions table 402 for storing transition data, according to some example embodiments. In the member positions table 402, each row includes information about one member position as well as information about the member (e.g., profile information about the member). If there is a previous position, information about the previous position is also included.

The member positions table 402 keeps the association between position titles and companies, as well as function, industry, and so forth. The member positions table 402 may be used for handling queries regarding hires, departures, and talent flows across companies, among other things. In addition, the member positions table 402 may be used to determine industry transitions because each row includes one or more fields regarding industry transitions. In some example embodiments, the member positions table 402 may be used to get headcounts at a given point in time.

In some example embodiments, the member positions table 402 includes the following fields: member identifier, one or more skill identifiers, country code, region code, one or more languages, and or more a school identifiers, one or more degree identifiers, one or more degree rollup identifiers, graduation year, gender, one or more field-of-study identifiers, previous organization identifier, organization identifier, previous industry identifier, industry identifier, previous seniority identifier, seniority identifier, previous function identifier, function identifier, previous super-title identifier, super-title identifier, previous title identifier, title identifier, flag indicating if the job is current, flag indicating if there is an industry transition, flag indicating if the member is hired, flag indicating if the member has departed, months at the company, months in position, employment status identifier, start date, end date, start-date quarter, and end-date quarter.

If there is no transition for this position, the previous organization identifier will be empty. Therefore, a transition is identified when the previous organization identifier is not empty. In addition to transition information, member data is included, such as skills, titles, functional area, etc.

For example, to identify all the transitions of a member, the table 402 may be searched by member identifier having non-empty previous organization identifiers. In another example, to identify all the transitions for a certain skill between two given companies, a search indicating the previous company identifier, the company identifier, and the skill will generate the data to create the report. Additionally, transitions between industries may be identified by searching the field previous industry identifier. A possible query to the member positions table 402 may specify: “find all the people that previously worked at company 1 and now work at company 2.”

As described earlier, indices may be created in the database to quickly access fields commonly used for searches, such as member identifier, previous organization identifier, organization identifier, skills, etc.

In some example embodiments, the following schema identifies the field; in the member positions table 402:

```
{
  “schemaName”: “memberPositions”,
  “dimensionFieldSpecs”: [
    {
      “name”: “memberId”,
      “dataType”: “LONG”
    },
    {
      “name”: “skillIds”,
      “dataType”: “INT”,
      “singleValuefield”: false
    },
    {
      “name”: “countryCode”,
      “dataType”: “STRING”
    },
    {
      “name”: “regionCode”,
      “dataType”: “INT”
    },
    {
      “name”: “languages”,
      “dataType”: “STRING”,
      “singleValueField”: false
    },
    {
      “name”: “schoolIds”,
      “dataType”: “INT”,
      “singleValueField”: false
    },
    {
      “name”: “degreeIds”,
      “dataType”: “INT”,
      “singleValueField”: false
    },
    {
      “name”: “degreeRollupIds”,
      “dataType”: “INT”,
      “singleValueField”: false
    },
    {
      “name”: “graduationYear”,
      “dataType”: “INT”
    },
    {
      “name”: “gender”,
      “dataType”: “STRING”,
      “defaultNullValue”: “U”
    },
    {
      “name”: “fieldsOfStudyIds”,
      “dataType”: “INT”,
      “singleValueField”: false
    },
    {
      “name”: “previousOrganizationId”,
      “dataType”: “INT”
    },
    {
      “name”: “organizationId”,
      “dataType”: “INT”
    },
    {
      “name”: “previousIndustryId”,
      “dataType”: “INT”
    },
    {
      “name”: “industryId”,
      “dataType”: “INT”
    },
    {
      “name”: “previousSeniorityId”,
      “dataType”: “INT”
      },
    {
      “name”: “seniorityId”,
      “dataType”: “INT”
    },
    {
      “name”: “previousFunctionId”,
      “dataType”: “INT”
    },
    {
      “name”: “functionId”,
      “dataType”: “INT”
    },
    {
      “name”: “previousSuperTitleId”,
      “dataType”: “INT”
    },
    {
      “name”: “superTitleId”,
      “dataType”: “INT”
    },
    {
      “name”: “previousTitleId”,
      “dataType”: “INT”
    },
    {
      “name”: “titleId”,
      “dataType”: “INT”
    },
    {
      “name”: “isCurrent”,
      “dataType”: “BOOLEAN”,
      “defaultNullValue”: “false”
    },
    {
      “name”: “isIndustryTransition”,
      “dataType”: “BOOLEAN”,
      “defaultNullValue”: “false”
    },
    {
      “name”: “isHire”,
      “dataType”: “BOOLEAN”,
      “defaultNullValue”: “false”
    },
    {
      “name”: “isDeparture”,
      “dataType”: “BOOLEAN”,
      “defaultNullValue”: “false”
    },
    {
      “name”: “monthsAtCompany”,
      “dataType”: “INT”
    },
    {
      “name”: “monthsInPosition”,
      “dataType”: “INT”
    },
    {
      “name”: “employmentStatusId”,
      “dataType”: “INT”
    },
    {
      “name”: “startMonthsSinceEpoch”,
      “dataType”: “INT”
    },
    {
      “name”: “endMonthsSinceEpoch”,
      “dataType”: “INT”
    },
    {
      “name”: “startQuartersSinceEpoch”,
      “dataType”: “INT”
    },
    {
      “name”: “endQuartersSinceEpoch”,
      “dataType”: “INT”
    }
  ]
}
```

It is noted that the embodiments illustrated in FIG. 5 are examples and do not describe every possible embodiment. Other embodiments may utilize different fields, fewer fields, additional fields, sorting fields in a different order, creating different indices, etc. The embodiments illustrated in FIG. 5 should therefore not be interpreted to be exclusive or limiting, but rather illustrative.

FIG. 6 illustrates a member profile table 403 for storing current position data by user, according to some example embodiments. The member profile table 403 includes one row per member. Therefore, information about the current member positions are stored in one row.

The member profile table 403 is used to optimize queries that might have been satisfied with the member positions table 402. However, instead of querying the member positions table 402 with a distinct count query, such as “select distinctCountHll(memberId) from memberPositions where skillIds in (‘19’, ‘20’) group by organizationId”, which may take a long time to process (e.g., 30 seconds), the member profile table 403 may be queried with a regular count(*) query, which greatly improves response time because the information for one member is kept in the same entry. In some example embodiments, the member profile table 403 may be used for obtaining information about company demographics associated with the current state.

In one example embodiment, the member profile table 403 includes the following fields: member identifier, list of current company identifiers, list of skill identifiers, list of current industry identifiers, one or more geographic identifiers, list of current seniority identifiers, list of current function identifiers, list of current super-title identifiers, list of current title identifiers, list of languages identifiers, list of school identifiers, list of degrees identifiers, graduation year, gender, list of field of study identifiers, list of current employment status identifiers, months of experience, and flag indicating if user is an employee of a small company.

In some example embodiments, the following schema identifies the fields in the member profile table 403:

```
{
  “schemaName”: “memberProfile”,
  “dimensionFieldSpecs”: [
    {
      “name”: “currentOrganizationIds”,
      “dataType”: “INT”,
      “singleValueField”: false
    },
    {
      “name”: “skillIds”,
      “dataType”: “INT”,
      “singleValueField”: false
    },
    {
      “name”: “truncatedSkillIds”,
      “dataType”: “INT”,
      “singleValueField”: false
    },
    {
      “name”: “currentIndustryIds”,
      “dataType”: “INT”,
      “singleValueField”: false
    },
    {
      “name”: “countryCode”,
      “dataType”: “STRING”
    },
    {
      “name”: “regionCode”,
      “dataType”: “INT”
    },
    {
      “name”: “currentSeniorityIds”,
      “dataType”: “INT”,
      “singleValueField”: false
    },
    {
      “name”: “currentFunctionIds”,
      “dataType”: “INT”,
      “singleValueField”: false
    },
    {
      “name”: “currentSuperTitleIds”,
      “dataType”: “INT”,
      “singleValueField”: false
    },
    {
      “name”: “currentTitleIds”,
      “dataType”: “INT”,
      “singleValueField”: false
    },
    {
      “name”: “languages”,
      “dataType”: “STRING”,
      “singleValueField”: false
    },
    {
      “name”: “schoolIds”,
      “dataType”: “INT”,
      “singleValueField”: false
    },
    {
      “name”: “degreeIds”,
      “dataType”: “INT”,
      “singleValueField”: false
    },
    {
      “name”: “degreeRollupIds”,
      “dataType”: “INT”,
      “singleValueField”: false
    },
    {
      “name”: “graduationYear”,
      “dataType”: “INT”
    },
    {
      “name”: “gender”,
      “dataType”: “STRING”,
      “defaultNullValue”: “U”
    },
    {
      “name”: “fieldsOfStudyIds”,
      “dataType”: “INT”,
      “singleValueField”: false
    },
    {
      “name”: “currentEmploymentStatusIds”,
      “dataType”: “INT”,
      “singleValueField”: false
    },
    {
      “name”: “monthsOfExperience”,
      “dataType”: “INT”
    },
    {
      “name”: “isSmallCompanyEmployee”,
      “dataType”: “BOOLEAN”,
      “defaultNullValue”: “false”
    }
  ]
}
```

The member geo transitions table 404 (shown in FIG. 4A) includes information regarding counts related to member location transitions. In some example embodiments, the member geo transitions table 404 includes the following fields: member identifier, primary organization identifier, super-title identifier, title identifier, list of skilled identifiers, industry identifier, previous country code, country code, previous region code, region code, previous state code, current state code, seniority identifier, list of function identifiers, list of languages, list of school identifiers, list of degree identifiers, graduation year, gender, list of fields of study identifiers, employment status identifier, transition date, and transition quarter.

Similar to the previous company identifier, the previous country code may be used to identify transitions between countries, or some other geographical areas.

The member education table 405 (shown in FIG. 4A) is utilized for querying education analytics, such as getting a list of recent graduates. Each row includes information about a member's attained degree at the school and includes information about the member's current position. The member education table 405 also includes information about the member's positions and transitions.

In one example embodiment, the member education table 405 includes the following fields: member identifier, the school identifier, degree identifier, degree rollout identifier (which includes an identifier for standardizing on different types of degrees), list of current company identifiers, list of skilled identifiers, list of current industry identifiers, one or more geographical codes, list of current seniority identifiers, list of field of study identifiers, list of language identifiers, list of current function identifiers, list of current super-title identifiers, list of current title identifiers, list of employment status identifiers, graduation year, gender, flag indicating if member is employed, starting date, end date, start quarter, and end quarter.

The job postings table 406 (shown in FIG. 4A) includes job posts information, which includes current job posts and a history of jobs posted over time. The job postings table 406 is utilized to query for job-post analytics and includes one row per job post.

In some example embodiments, the job postings table 406 includes the following fields: organization identifier, list of skilled identifiers, seniority identifier, one or more geographical codes, industry identifier, list of function identifiers, list of super-title identifiers, list of title identifiers, job type identifier, date posted, and quarter posted.

The employer engagement table 407 (shown in FIG. 4A) includes information about interactions of members with a company, such as company page viewers, content viewers, job viewers, and in-network communications between social network members. For example, the employer engagement table 407 is used to track company posts on the social network feed and the respective clicks, likes, and shares, etc., on those posts. Is also used to track job posts, job abuse, and job clicks by members, as well as emails sent or replies received. In general, it covers all kinds of interactions with a particular company.

The employer engagement table 407 is utilized for querying member engagement analytics. For example, how well a company is performing compared with other companies with reference to member engagement.

In some example embodiments, the employer engagement table 407 includes the following fields: member identifier, engagement organization identifier, list of member current organization identifiers, list of member previous organization identifiers, list of skilled identifiers, list of current seniority identifiers, list of previous seniority identifiers, one or more geographical codes, list of school identifiers, list of degrees identifiers, graduation year, list of field of study identifiers, list of languages, list of current industry identifiers, list of previous industry identifiers, list of current function identifiers, list of previous function identifiers, list of current super-title identifiers, list of previous super-title identifiers, list of current title identifiers, list of previous title identifiers, list of employment status identifiers, gender, date, quarter, organization page view account, organization follow, organization share count, job views count, job applications count, in-network received emails count, in-network email responses count, and date.

It is noted that the embodiments described above are examples and do not describe every possible embodiment. Other embodiments may utilize different fields, fewer fields, and additional fields, and may sort fields in a different order, create different indices, etc. The embodiments should therefore not be interpreted to be exclusive or limiting, but rather illustrative.

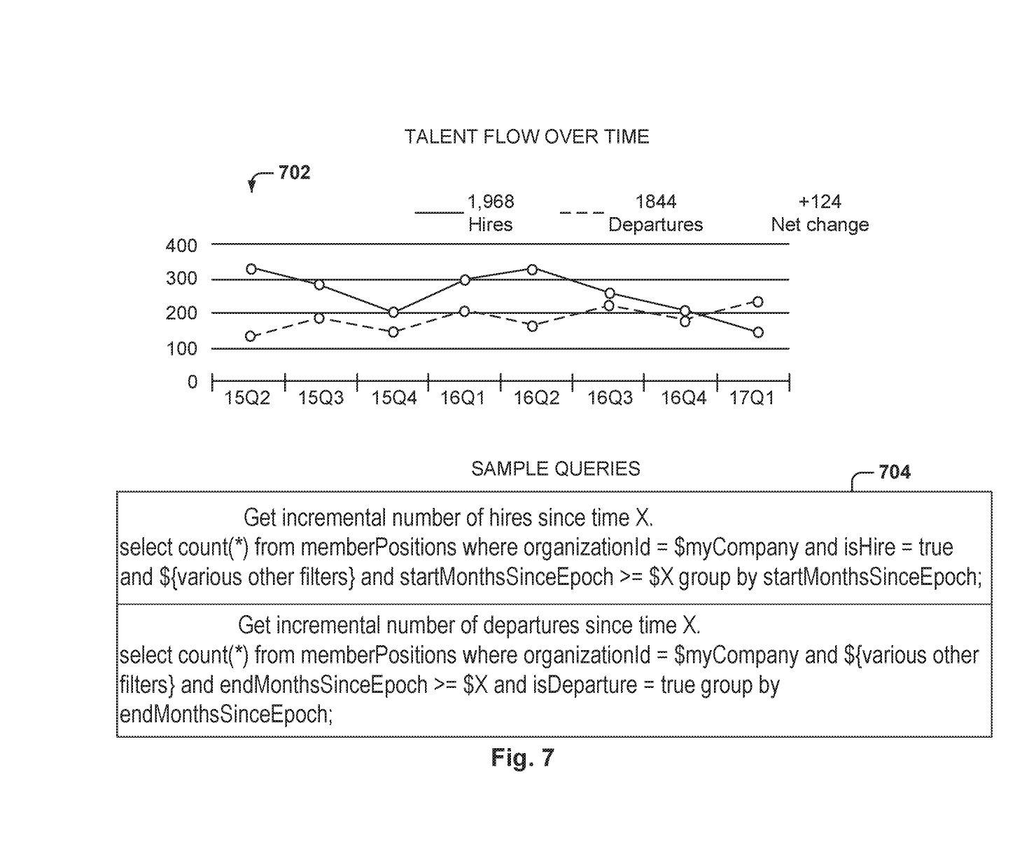

FIG. 7 illustrates a report for talent flow over time and related queries, according to some example embodiments. In general, there are two types of reports: reports with information about a given company, and reports that compare the performance of multiple companies.

Chart 702 is a talent flow over time. It illustrates the evolution of the number of hires and departures of the company by quarter. It also provides the total of the number of hires, the total number of departures, and the net change.

Sample queries 704 illustrate some queries that may be used to obtain the report data related to talent flow. A first query may be used to get the incremental number of hires since a certain time X, as follows:

```
select count(*) from memberPositions where
    organizationId = $myCompany and isHire = true and
    ${various other filters} and
    startMonthsSinceEpoch>=$X
    group by startMonthsSinceEpoch;
```

Another query to get the incremental number of departures since time X is:

```
select count(*) from memberPositions where
    organizationId = $myCompany and
    ${various other filters} and
    endMonthsSinceEpoch >= $X and
    isDeparture = true group by endMonthsSinceEpoch;
```

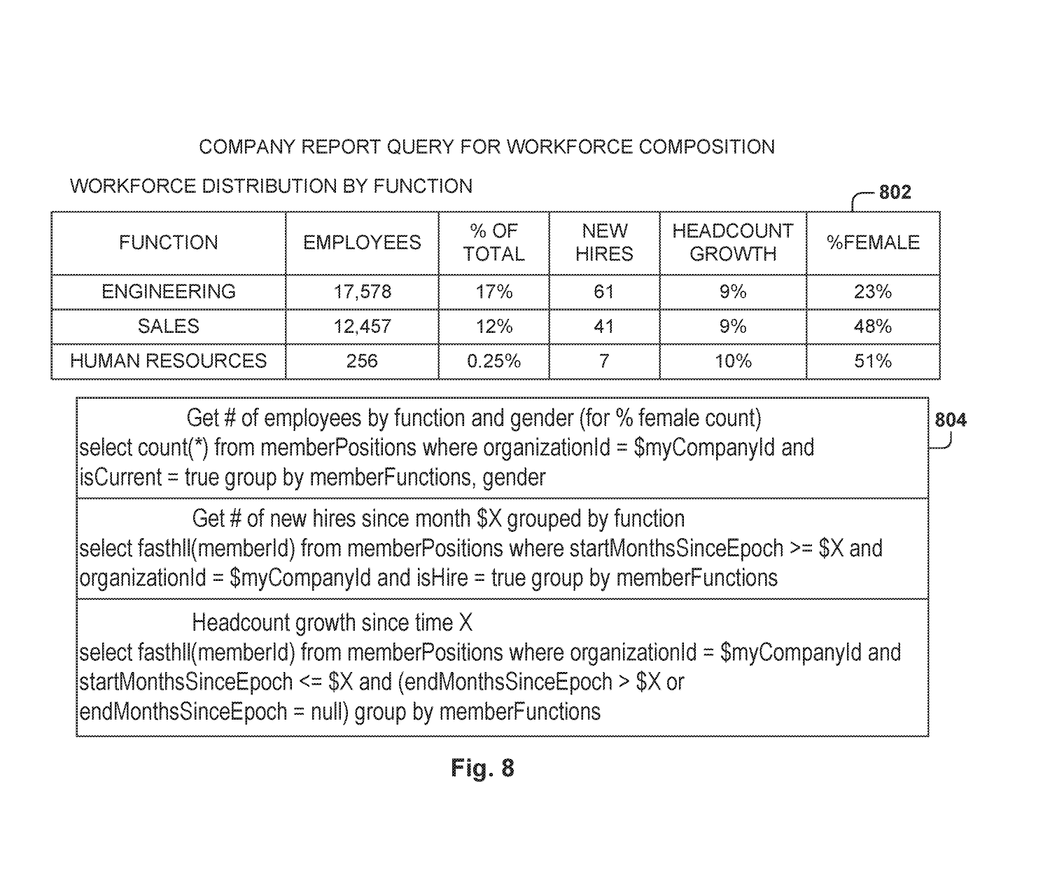

FIG. 8 illustrates a table for workforce distribution by function and related queries, according to some example embodiments. A report shown in table 802 includes statistical data by function (e.g., engineering, sales, human resources), although other functions may also be included. For each function, the number of employees, the percentage of total employees, the number of new hires, the headcount growth, and the percentage of female employees are provided.

Sample queries 804 are provided as examples on queries utilized to get this information. A first query to get the number of employees by function and gender, for female count, is as follows:

```
select count(*) from memberPositions where
    organizationId = $myCompanyId and isCurrent = true
    group by memberFunctions, gender
```

A second query to get the number of hires since month X grouped by function is:

```
select count(memberId) from memberPositions where
    startMonthsSinceEpoch >= $X and
    organizationId = $myCompanyId and
    isHire = true group by memberFunctions
```

Another query to get the headcount growth since time X is:

```
select distinctcounthll(memberId) from memberPositions
where
    organizationId = $myCompanyId and
    startMonthsSinceEpoch <= $X and
    (endMonthsSinceEpoch > $X or
    endMonthsSinceEpoch = null)
    group by memberFunctions
```

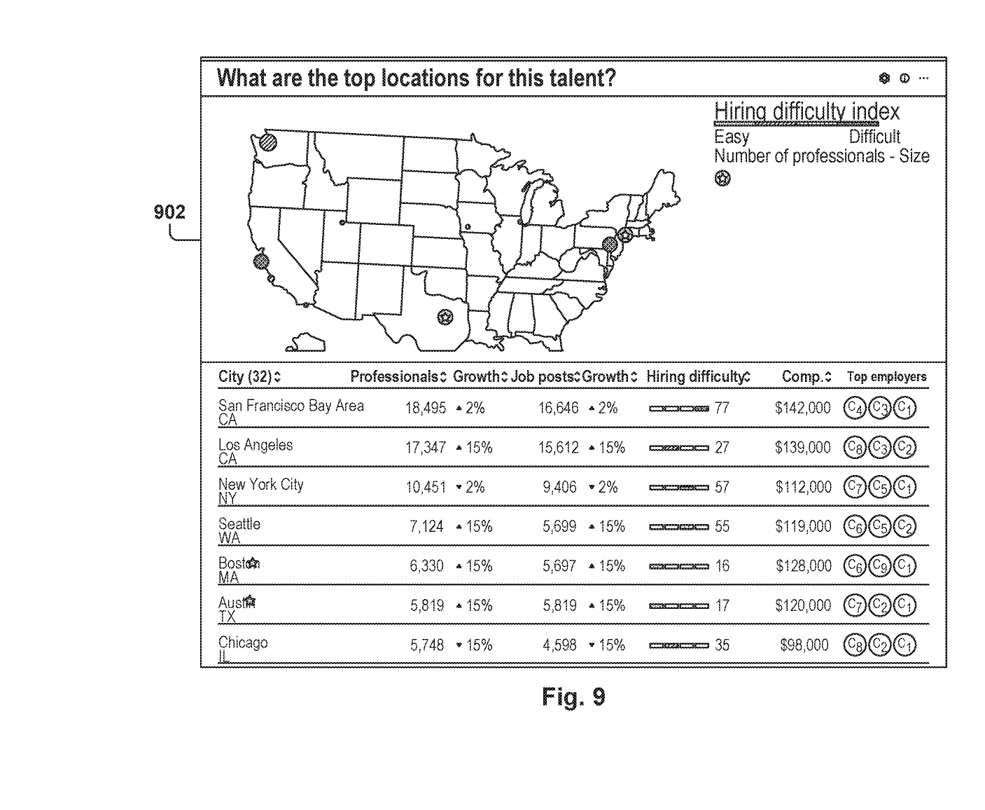

FIG. 9 is a talent geographic map 902, according to some example embodiments. Supply indicates how many employees are available while demand shows how many companies are hiring for the given super-title. By analyzing supply and demand, it is possible to identify geographies where the number of open job positions is much higher than the supply of skilled workers to field those jobs. In this case, there is a shortage, and it will be difficult to hire in that location, or it will be expensive.

In addition, knowing which companies have these workers allows the hiring manager to identify competition for this type of talent. Also, it is possible to see attrition at a company. In this case, employees at this company may be receptive to discussing employment opportunities.

The map 902 illustrates the top locations for this type of talent. The map 902 includes circles that are colored based on the hiring difficulty index. Thus, there may be some circles indicating where it is difficult to hire, or other circles that indicate “hidden gems” with a large supply of the desired employees.

A table beneath the map 902 shows data by location, indicating the number of professionals in the area, the annual growth in the number of professionals, the number of job posts, the growth in job posts, a hiring difficulty index based on the supply and demand for the region, average compensation, and the top employers in the region (e.g., C₄, C₃, C₁), which may be represented by name, logo, or both.

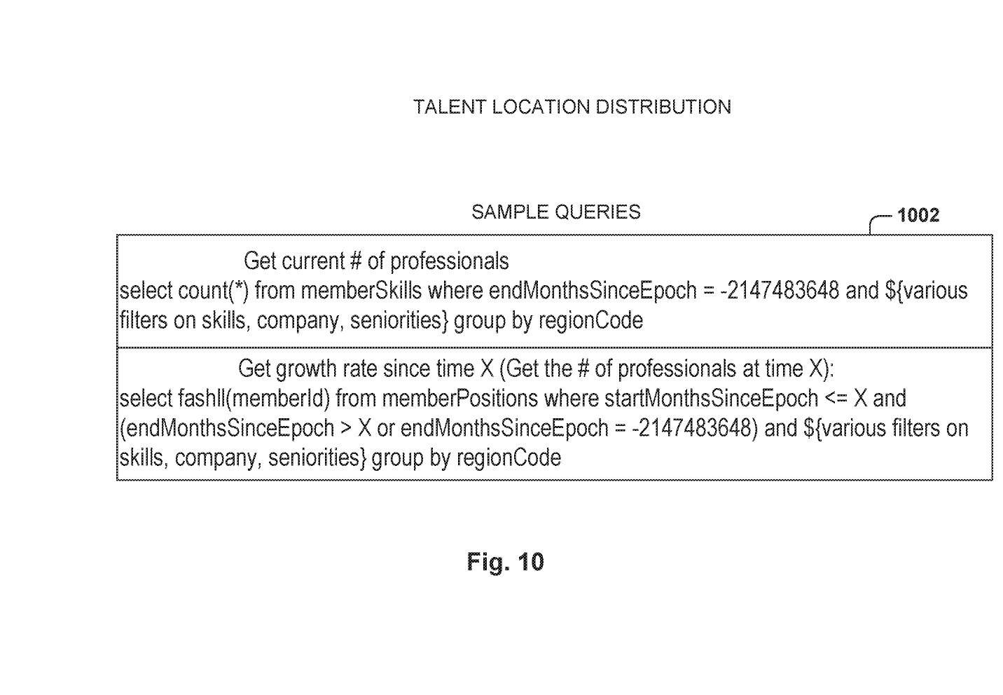

FIG. 10 illustrates sample queries 1002 for the talent location distribution, according to some example embodiments. A query to get the current number of professionals is:

```
select count(*) from memberProfile where
    endMonthsSinceEpoch = −2147483648 and
    ${various filters on skills, company, seniorities}
    group by regionCode
```

To get the growth rate since time X, the following query may be performed:

```
select distinctcounthll(memberId) from memberPositions
where
    startMonthsSinceEpoch <= X and
    (endMonthsSinceEpoch > X or
    endMonthsSinceEpoch = −2147483648) and
    ${various filters on skills, company, seniorities}
    group by regionCode
```

FIG. 11 is a report for talent flow between companies, according to some example embodiments. FIG. 11 provides a dashboard 1102 for talent flow insights. A top section 1104 includes a summary with charts for the number of employees over time, and the number of hires and departures over time. The charts show that the number of employees has steadily grown over time, but that in recent times the number of hires and departures is similar, indicating lack of employee growth at the company.

Further, a bottom section 1106 indicates how the talent flows by company. The table includes an entry for each company with hires or departures with respect to Company 237, and includes the double horizontal bar for departures and hires. As shown, if a mouse is placed over the bar, additional information is provided. Other columns indicate the net gain of employees, the ratio between hires and departures, and a color-coded representation of the inflow or outflow, by quarter.

For each quarter, a color-coded square shows an indication of the employee flow. For example, the squares for the first entry for company C₁, show a prevalent red color, which indicates that the company has been losing employees to company C₁. On the other hand, the squares for company C₁₀ are mainly green, indicating that the company has been gaining talent from C₁₀.

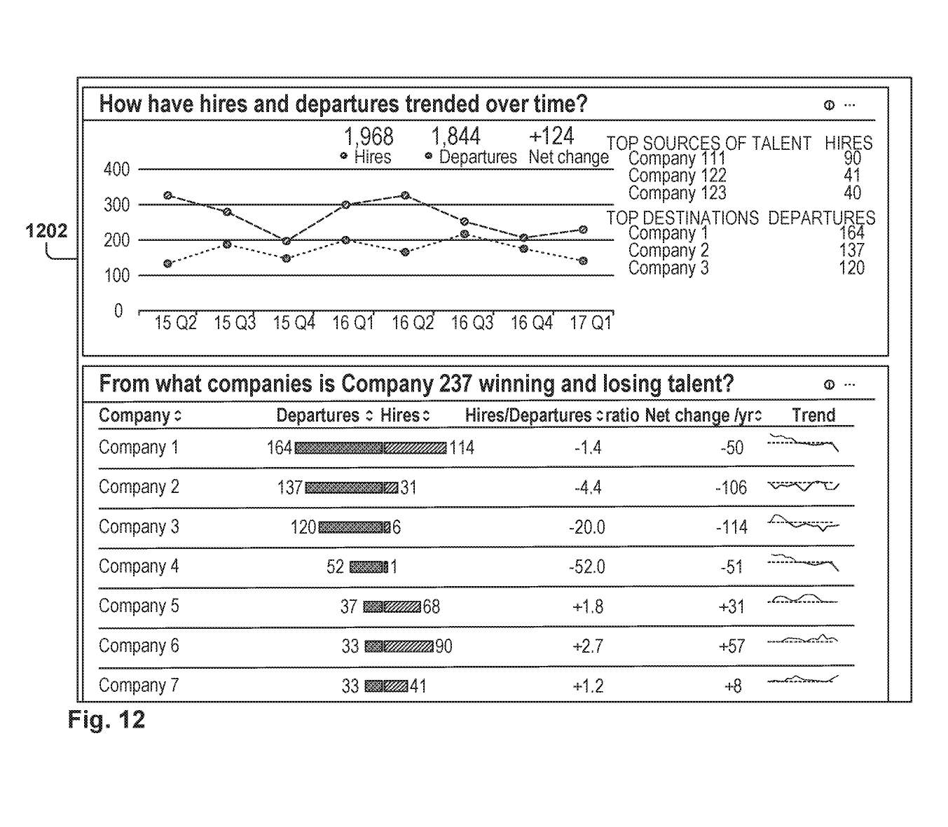

FIG. 12 is a timeline for hires and departures of a given company, according to some example embodiments. Chart 1202 illustrates hires and departure data over time. A top chart shows lines for the number of hires and the number of departures by quarter. Additionally, the companies that are the top sources for talent and the top destinations are shown in tabular form on the right, including the number of hires or departures.

Further, a mixed tabular and graphical summary is presented below to indicate from which companies Company 237 is winning and losing talent. The table includes one entry per company, and for each company, a comparison of the departures and hires, a hires to departure ratio, a net change per year for hires or departures (color coded: red for losing talent and black for gaining talent), and a historical line showing evolution over time.

The departures-versus-hires column includes a bar with an origin point. The size of the bar grows to the left in proportion to the number of departures and grows to the right in proportion to the number of hires. Additionally, the actual number of departures or hires is shown next to the bar. This is a useful graphical representation because it is easy to quickly see how the company is gaining or losing employees to the respective company in the chart. For example, it is clear to see that Company 237 is losing employees to companies 1-4 but gaining employees with reference to companies 5-7.

A query to obtain the count of departures from companyX grouped by destination company in the past two years is as follows:

```
select count(*) from memberPositions where
    previousOrganizationId = $companyX and
    startMonthsSinceEpoch > $currentMonthsSinceEpoch −
    24 group by organizationId top 100
```

FIG. 13 is a report for head-to-head comparison of talent flow between two companies, according to some example embodiments. Chart 1302 provides a breakdown of information comparing two companies, and the flow of talent between the companies.

Summary values are provided, including the number of hires, the number of departures, the net gain of employees, the ratio, and the number of employees that return to one of the companies. The chart on the right provides detailed information by function or seniority.

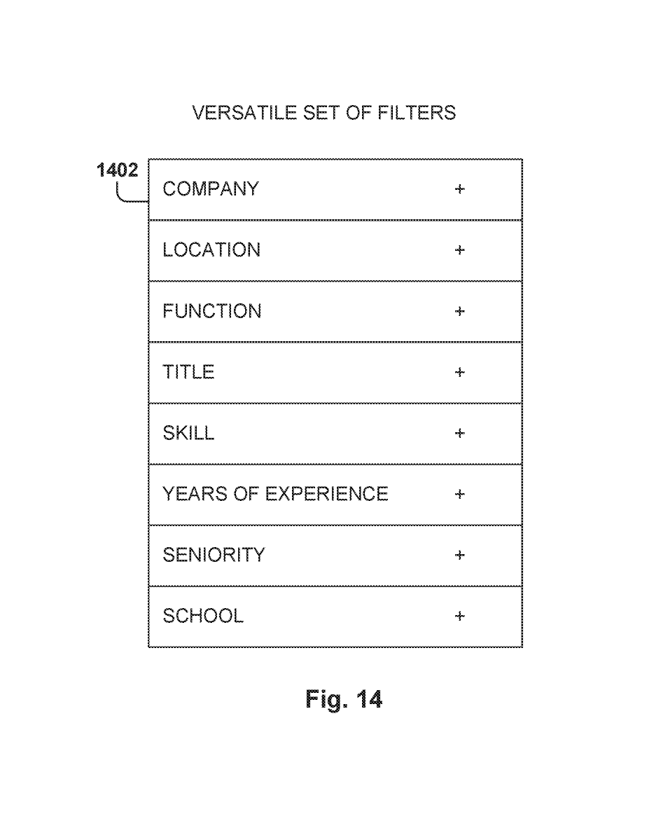

FIG. 14 illustrates some of the filtering possibilities for report generation, according to some example embodiments. The report user interface 1402 provides multiple filters to obtain a wide variety of reports.

In some example embodiments, the filters include company filters, location filters, function filters, title filters, skill filters, years of experience filters, seniority, and school. In other embodiments, a different combination of filters or additional filters may be provided. All the fields identified in the talent tables may be used for filtering.

For each of the filters, the user may provide a specific value (e.g., a company name), provide values for given ranges (e.g., 5 to 10 years of experience), or even values with search expressions (e.g., “give me companies that start with A in California”), etc.

This rich variety of filters provides great flexibility to the user for generating reports of interest. For example, a report may be generated for unicorn companies, which are non-public companies valued at more than one billion dollars. The reports presented herein are just a sample of the great flexibility and variety of possible reports.

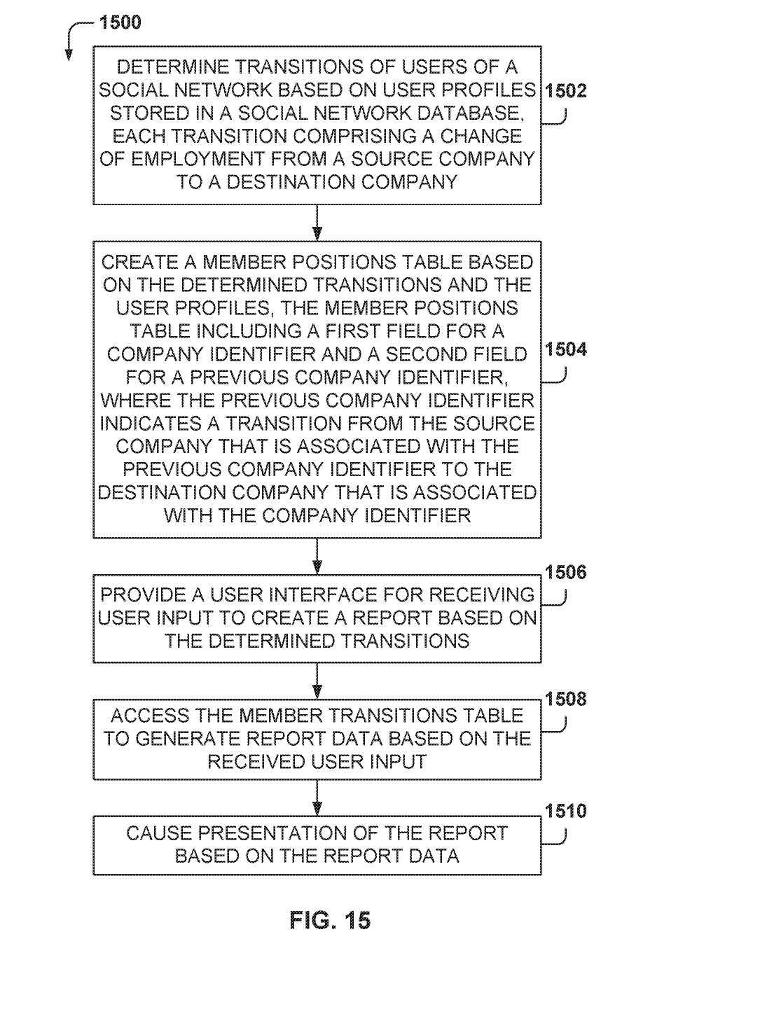

FIG. 15 is a flowchart of a method 1500, according to some example embodiments, for analyzing and generating employee mobility information. While the various operations in this flowchart are presented and described sequentially, one of ordinary skill will appreciate that some or all of the operations may be executed in a different order, be combined or omitted, or be executed in parallel.

At operation 1502, one or more processors determine transitions of users of a social network based on user profiles stored in a social network database. Each transition comprises a change of employment from a source company to a destination company.

From operation 1502, the method 1500 flows to operation 1504 for creating, by the one or more processors, a member positions table based on the determined transitions and the user profiles. The member positions table includes a first field for a company identifier and a second field for a previous company identifier, where the previous company identifier indicates a transition from the source company that is associated with the previous company identifier to the destination company that is associated with the company identifier.

From operation 1504, the method 1500 flows to operation 1506, where the one or more processors provide a user interface for receiving user input to create a report based on the determined transitions. At operation 1508, the one or more processors access the member positions table to generate report data based on the received user input. At operation 1510, the one or more processors cause presentation of the report based on the report data.

In one example, the member positions table is a member positions table including one row per member position, the member positions table including fields for, at least, a member identifier, the previous company identifier, the company identifier, a title identifier, and a geographic identifier.

In one example, the member profile table is a member profile table including one row per member profile, the member profile table including fields for, at least, a member identifier, a list of company identifiers, a list of title identifiers, and a list of geographic identifiers.

In one example, creating the member positions table further comprises partitioning and sorting the member positions table by index segments based on company identifier, wherein information for a given company resides in one Pinot server, wherein each Pinot server comprises information for one or more companies.

In one example, a first report comprises information for a given company and tabular and graphic representations of head-to-head comparisons of the given company with other companies for a number of departures and a number of hires.

In one example, a second report comprises information for a given company including a chart showing a number of departures and a number of hires over time.

In one example, the method 1500 further comprises creating a member education table comprising information about education of users, wherein a third report presents information about educational institutions educating users with a given skill.

In one example, the method 1500 further comprises creating an employer engagement table with information about interactions of the users of the social network with one or more companies.

In one example, the method 1500 further comprises creating a job postings table with information about jobs posted over time on the social network.

In one example, the method 1500 further comprises creating a geographic transitions table with information about transitions between different geographic locations.

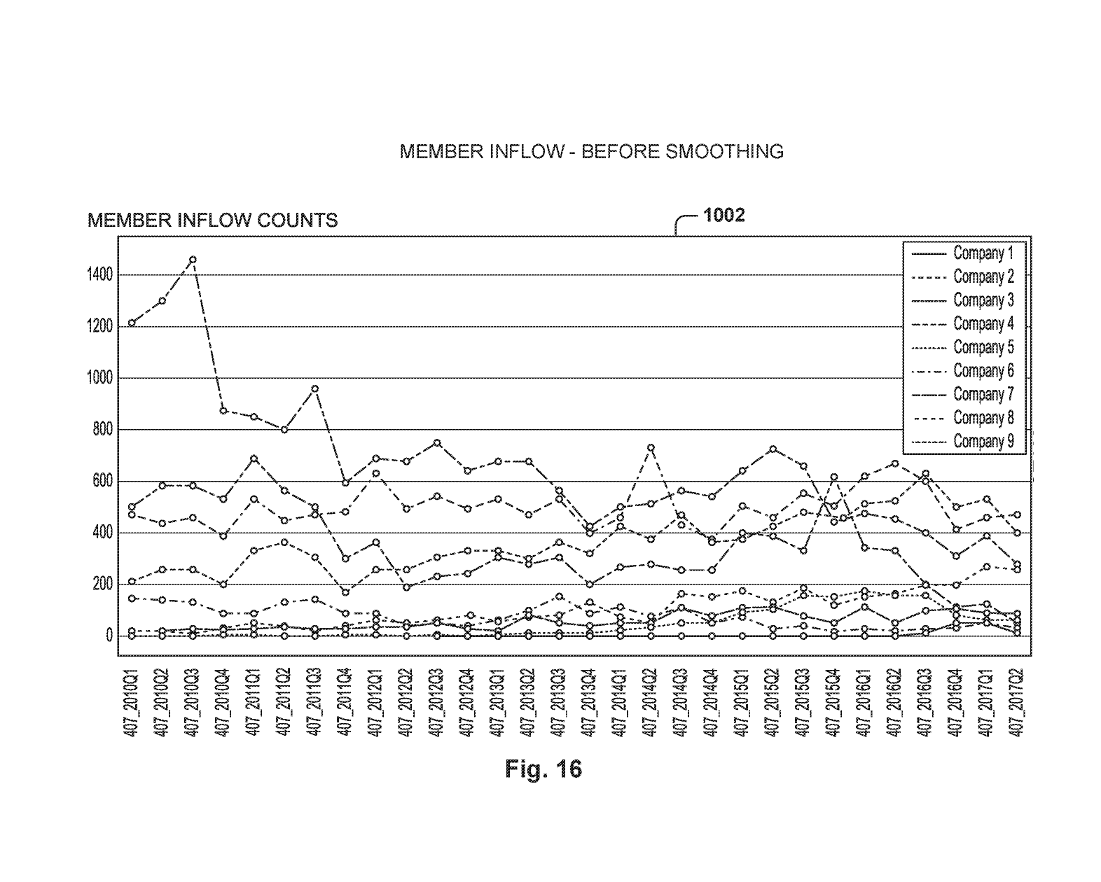

FIG. 16 is a report representing employee inflow over time for a plurality of companies before smoothing, according to some example embodiments. Chart 1602 shows the inflow of employees, per quarter, for a plurality of companies. It is easy to visually analyze how companies grow or shrink over time. Each point in the graph represents the inflow in a particular quarter for the company, and these points are joined by a line to show the evolution.

The chart 1602 of FIG. 16 includes the top nine companies with respect to new employees. Other charts may include the number of outgoing employees, or the net gain or loss of employees.

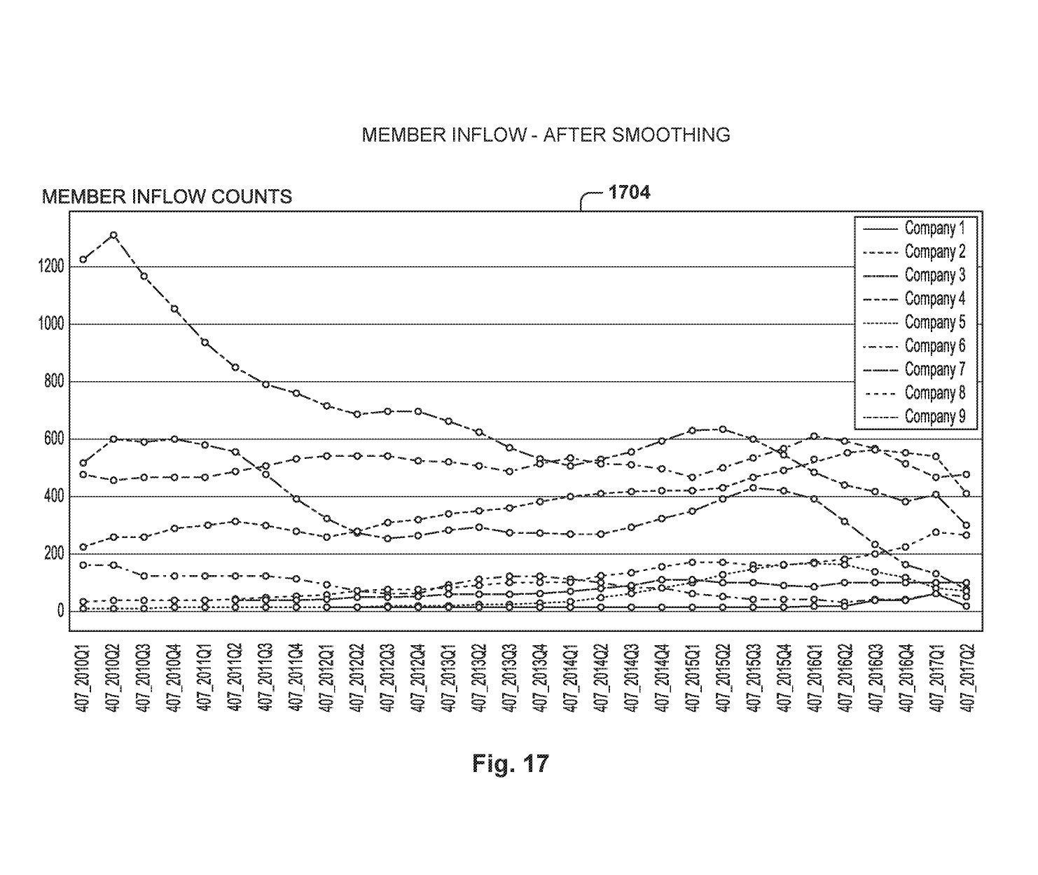

FIG. 17 is a report representing employee inflow over time for a plurality of companies after smoothing, according to some example embodiments. As seen in FIG. 16, the inflow data may include many abrupt spikes and valleys. In some example embodiments, data smoothing techniques are utilized to smooth the data over time, such as by calculating a weighted average over a predetermined number of periods, which could extend to the previous periods and future periods.

In one example embodiment, the smoothed inflow count numbers are calculated as:

Iₜ=⅛xₜ₋₂+¼xₜ₋₁+¼xₜ+¼xₜ₊₁+⅛xₜ₊2

Iₜ represents the weighted smoothed inflow for the period t being calculated, and xₜ corresponds to the inflow for the period t, where period t−1 is the previous period, period t+1 is the next period, etc. In some example embodiments, Iₜ is used instead of the inflow for the period for the calculation of the company score. Other embodiments may utilize different periods and different weights for the weighted-sum calculation, such as using the current period and the previous two periods, etc. Other exponential smoothing techniques may be utilized.

FIG. 17 shows the inflow chart 1702 after smoothing. In this case, it is easier to appreciate trends over a period of time as the lines tend to include fewer spikes and valleys.

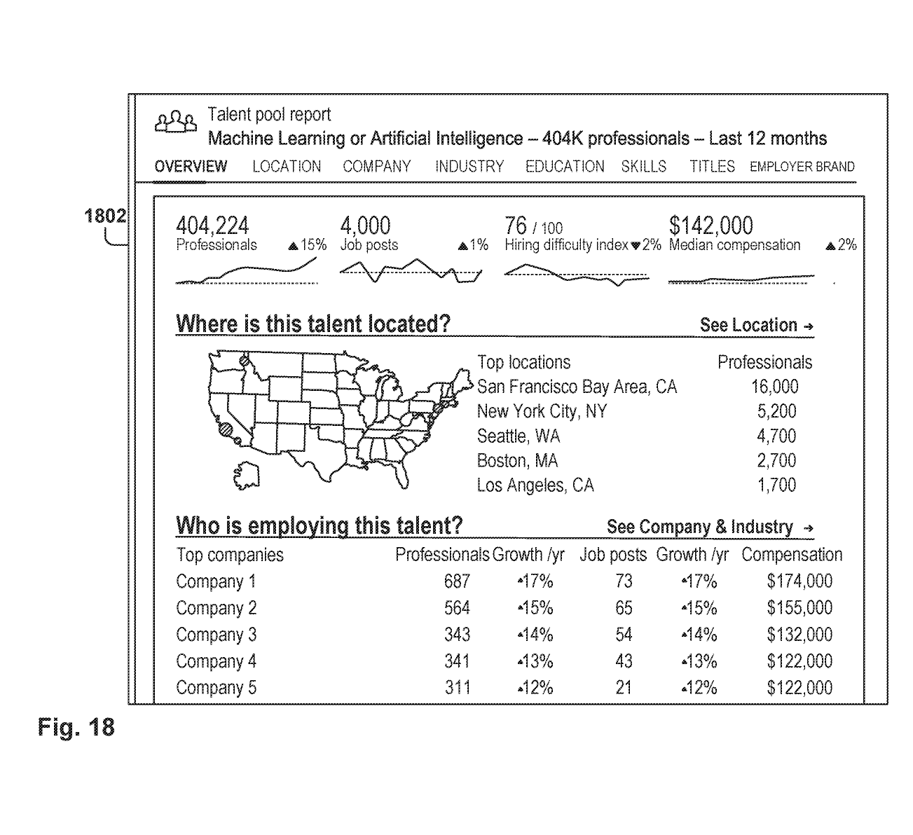

FIG. 18 is a talent pool report 1802, according to some example embodiments. A talent pool report is a type of report that enables finding any population of talent, based on skills, titles, geographies, and industries, while providing insights to help create a talent-acquisition strategy. For example, if the company wants to hire 200 engineers with machine-learning skills, the company may conduct a search to identify where the talent with machine-learning skills is located. This helps the company decide in which locations to hire and establish working teams, or at which locations it will be more expensive to hire employees.

The talent pool report 1802 is an example for a super-title of machine learning or artificial intelligence for the last 12 months. The report 1802 indicates that there are 404,224 professionals that match this skill in the geography of interest, the United States in this case.

The report 1802 includes numbers and graphical representation of the evolution of the professionals, the number of job posts identified in this period for machine learning, a hiring difficulty index, and the median compensation (together with respective growth indicators over the previous year).

Additionally, a map of the United States is shown with circles of varying sizes, in proportion to the number of employees at the location, for the identified super-title or super-titles. Additionally, a table shows the tabular representation for the locations and the number of professionals in these locations.

Further yet, the report 1802 includes a list of companies (e.g., top five) that are hiring this type of employee and a table is provided indicating, by company, the number of professionals employed at the company, the percentage growth by year, the number of job posts, the growth by each year in the number of job posts, and the median compensation.

A query to get the current number of professionals may be used, as follows:

```
select count(*) from memberPositions
    where isCurrent = true and
    ${various filters on skills, seniorities}
    group by organizationId
```

A query to get the growth rate since time X is:

```
select count(*) from memberPositions where
    startMonthsSinceEpoch <= X and
    (endMonthsSinceEpoch > X or isCurrent = true) and
    ${various filters on skills, company, seniorities}
    and organizationId in (123, 456, 789)
    group by organizationId
```

FIG. 19 is a talent-distribution report by company, according to some example embodiments. Chart 1902 shows the companies that are employing machine-learning employees. The data is represented in a table, but instead of a hiring difficulty index, a column with the attrition rate is provided. The attrition rate is represented numerically and as a graphical horizontal bar that is color-coded based on the attrition rate. For example, company 10 has shown a 43% attrition rate over the last year, indicating that the talent is leaving that company.

It is noted that the report includes 32 companies, although only 10 are presented; however, scrolling options are provided in the user interface for showing additional companies.

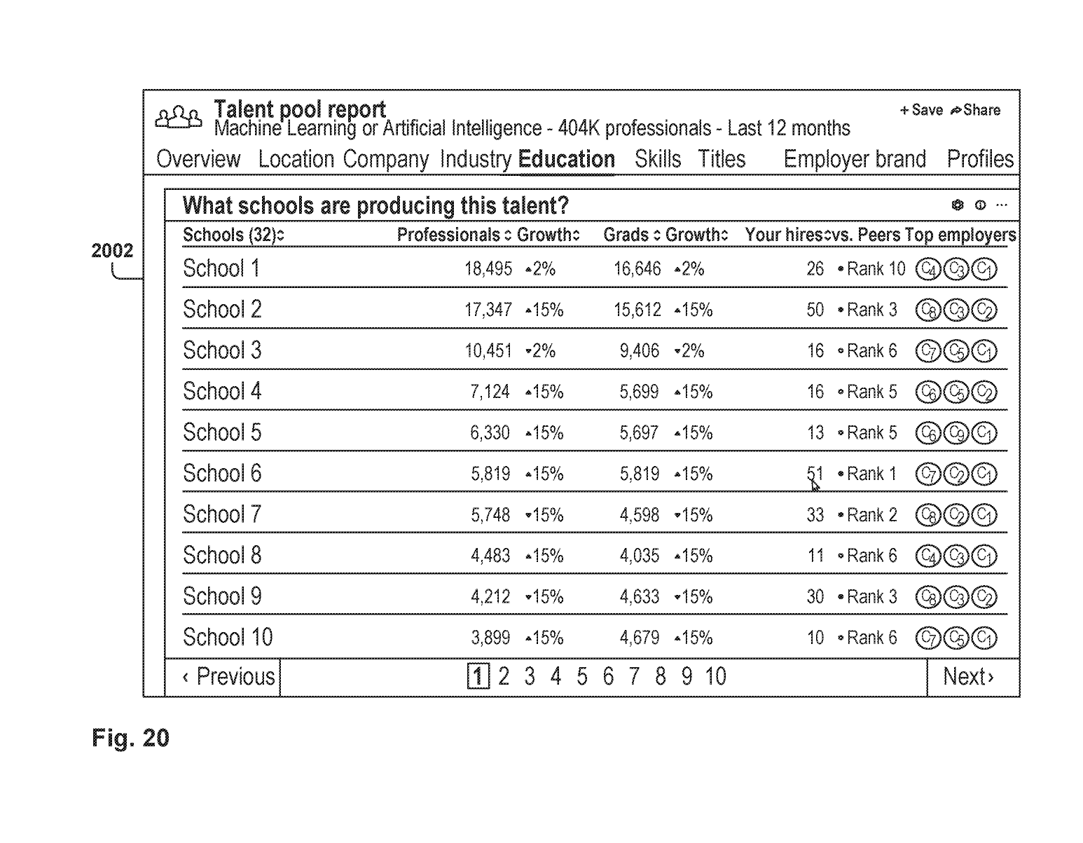

FIG. 20 is a talent report by educational institution, according to some example embodiments. It may also be very informative for a hiring manager to know which schools are providing the desired skills, especially for recent graduates. This way, the hiring manager may intensify hiring activities at the schools generating a large number of graduates with the desired skills.

Chart 2002 shows a talent pool report for the schools “producing” this type of talent. The table includes an entry for each school, and each entry includes the number of professionals who show in their profiles that they are graduates from the school, the annual percentage growth in the number of professionals, the number of recent graduates, the annual growth in the number of recent graduates, the number of hires for the company generating the report, ranking versus other peers, and the top employers indicated by their logos, although other embodiments may include their name. Chart 2002 includes 10 schools (e.g., universities) and scrolling options are provided to show additional schools.

A query to get the recent number of graduates (e.g., last 12 months) is:

```
select count(*) from memberEducation where
    monthSinceEpochGraduated >
    ($curMonthsSinceEpoch − 12)
group by schoolId
```

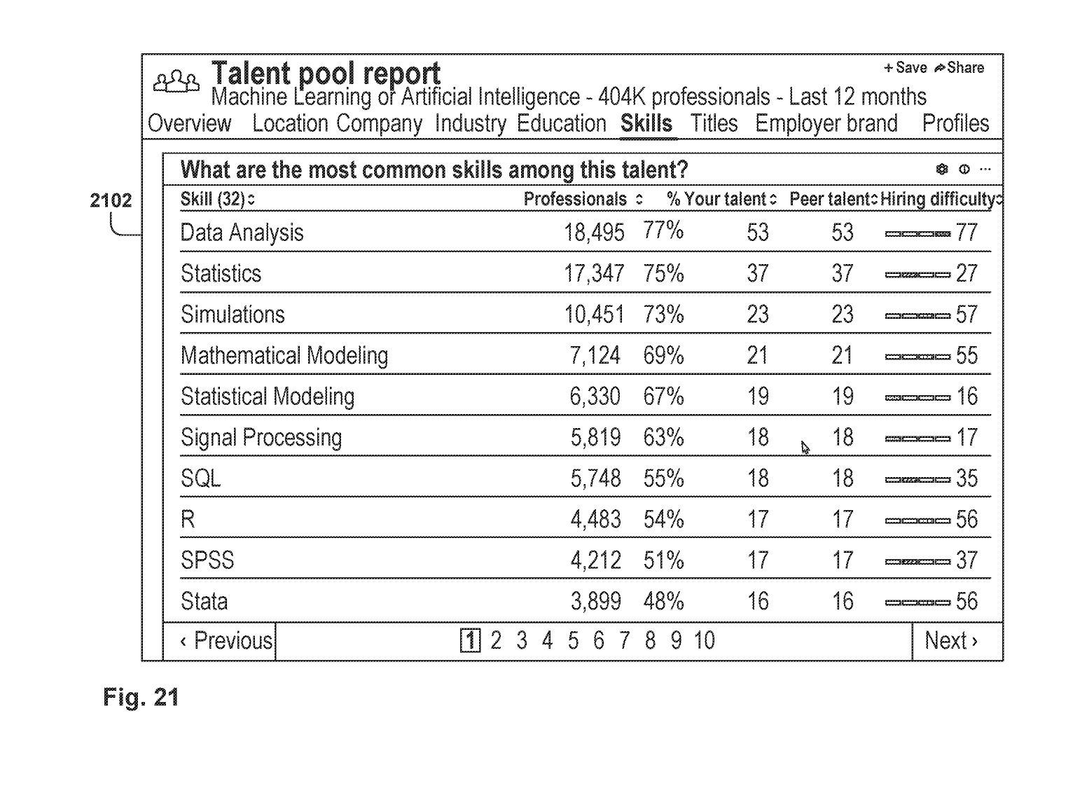

FIG. 21 is a talent report by user skill, according to some example embodiments. Sometimes, it may be difficult to hire the right person for a job, but it may be possible to hire people with similar skills and provide training and mentoring to get the desired skills. Therefore, an analysis of the skills identified by users in the profile may assist in targeting similar types of talent.

Chart 2102 represents the most common skills for a given talent (e.g., machine learning or artificial intelligence). The table includes an entry for each skill and is sorted by the number of professionals showing this skill within the target group. For each entry, the number of professionals identifying the skill is shown, as well as the percentage growth in the number of professionals, the number of employees of the present company showing this skill, the number of peers showing this skill, and the hiring difficulty for hiring employees that possess this skill. The hiring difficulty may be represented as a number and as a sliding scale.

For example, for machine learning. Data Analysis is identified as the most common skill, followed by Statistics, Simulations, Mathematical Modeling. Statistical Modeling, Signal Processing, etc. The table shows that hiring Data Analysis skills is relatively difficult, with a hiring difficulty of 77%. However, people with Statistical Modeling and Signal Processing have relatively low hiring difficulty ratios, so the hiring manager may decide to hire engineers with Statistical Modeling skills and train them to become data scientists.

A query to get the total distribution of skills is:

```
select count(*) from memberProfile where
    ${various filters}
    group by truncatedSkillIds
```

A query to get the distribution of skills for certain company X is:

```
select count(*) from memberProfile where
    ${various filters} and
    organizationId = $X group by truncatedSkillIds
```

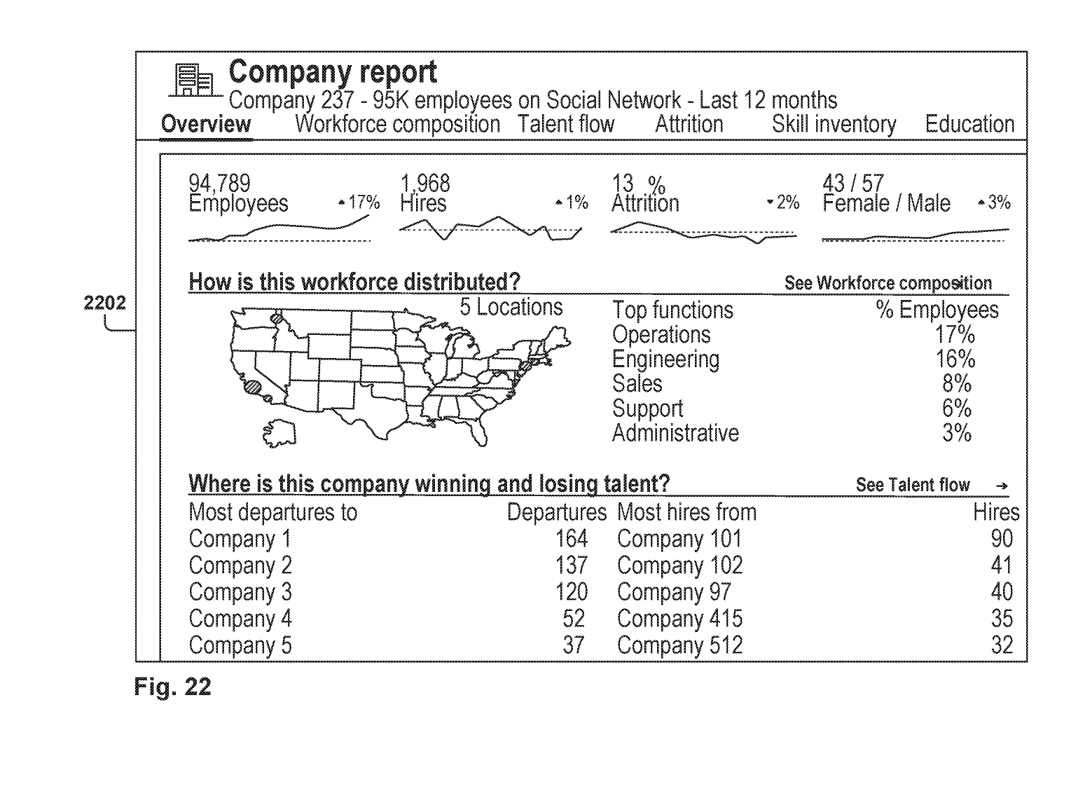

FIG. 22 is a workforce-distribution report for a company, according to some example embodiments. The company report for a particular company (e.g., Company 237 in this example) provides information about the labor composition of the company.

The company report 2202 shows that Company 237 has 94,789 employees with profiles in the social network over the last 12 months. The report 2202 further includes the number of employees, the number of hires, the attrition rate, and the ratio of female to male, with respective linear graphical representations of these values.

Additionally, the company report 2202 shows how the workforce is distributed for this company, illustrated by a map of the United States with circles proportional in size to the concentration of employees. A table next to the map also breaks down the percentage of employees by function, such as Operations, Engineering, Sales, Support, and Administrative.

Further below, a couple of tables indicate where the company is winning and losing talent. A first table on the left shows the companies where employees of Company 237 are going and the number of departures; and a second table on the right shows the companies from which Company 237 is hiring, together with the number of hires within the last 12 months. Company report 2202 provides a dashboard of information for the company as well as some information about competitors for talent.

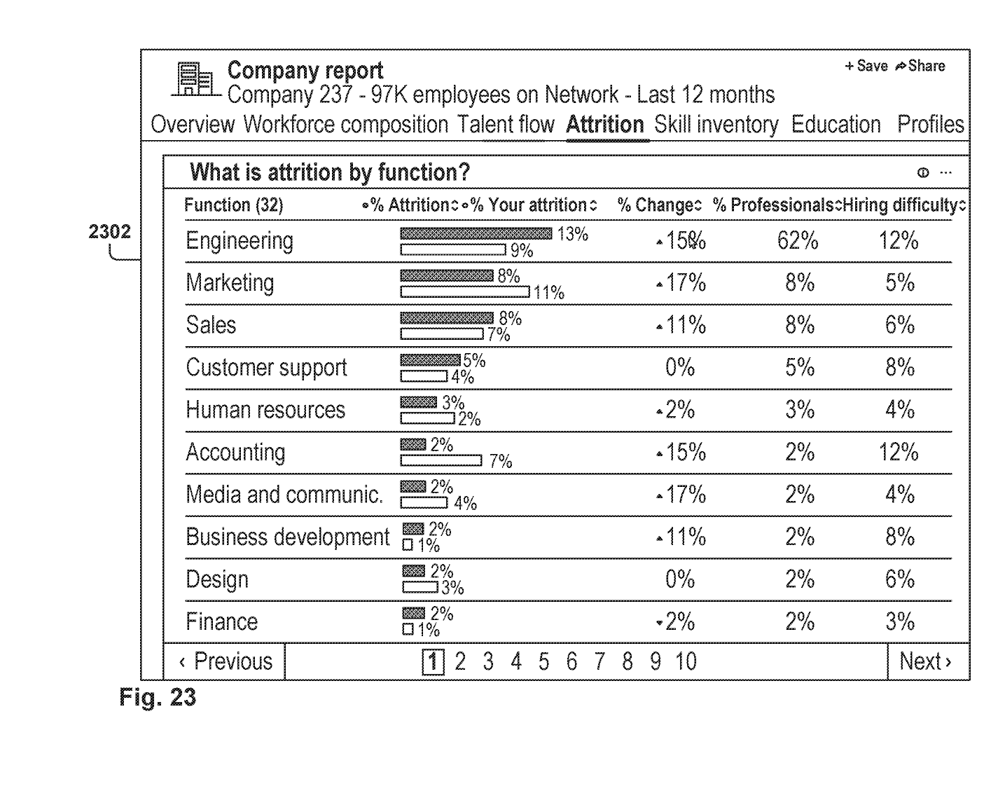

FIG. 23 is a company report by function, according to some example embodiments. Chart 2302 is a company report for a given company (Company 237) that shows the attrition by function. The data is represented in a tabular form with one entry for each function, which include Engineering, Marketing, Sales, Customer support, Human resources, etc.

For each function, two bars are presented, one bar for the attrition rate for the market and another bar for the attrition rate of the company. Other fields include the percentage change in the number of employees, the percentage of professionals within the company, and a hiring difficulty index for the function.

A query to get the number of departures since time X, grouped by function, is:

```
select count(*) from memberPositions where
    previousOrganizationId = $myCompany and
    endMonthsSinceEpoch >= $X and
    isDeparture = true
    group by functionIds
```

A query to get company attrition, growth by skill, is:

```
select count(*) from memberPositions where
    organizationId = $myCompany and
    endMonthsSinceEpoch >= $X and
    isDeparture = ‘true’
    group by skillIds
```

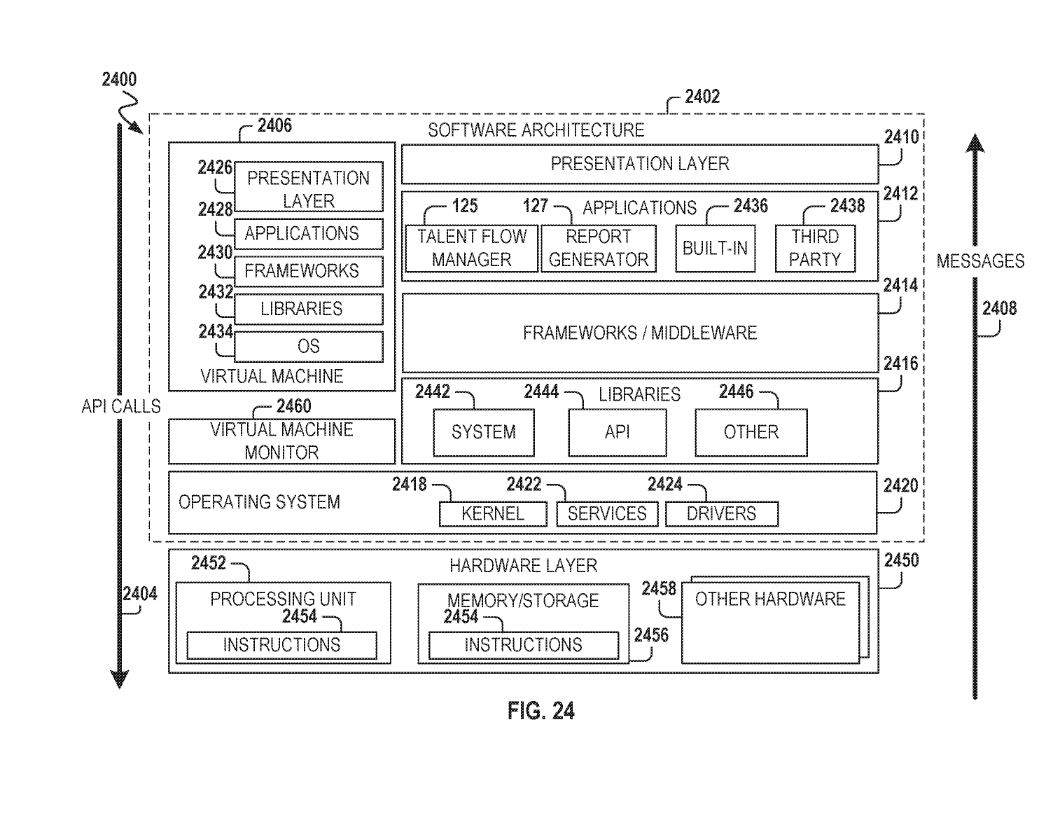

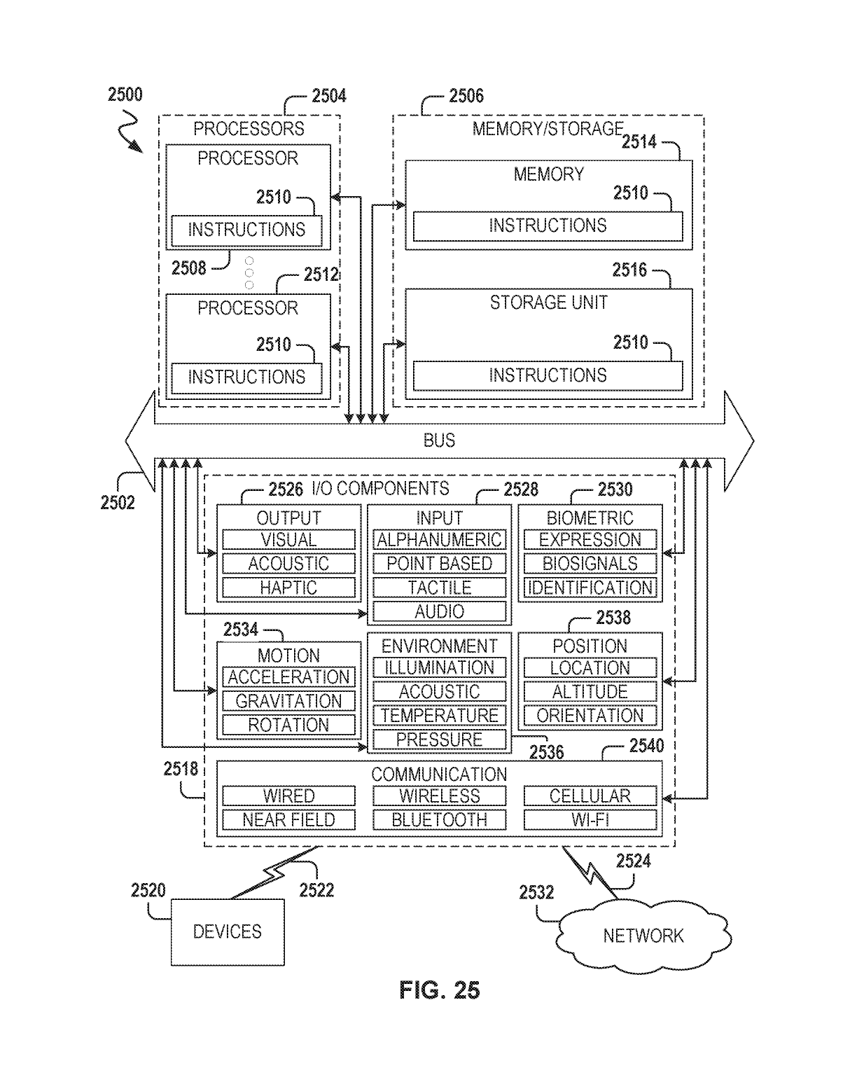

FIG. 24 is a block diagram 2400 illustrating a representative software architecture 2402, which may be used in conjunction with various hardware architectures herein described. FIG. 24 is merely a non-limiting example of a software architecture 2402, and it will be appreciated that many other architectures may be implemented to facilitate the functionality described herein. The software architecture 2402 may be executing on hardware such as a machine 2500 of FIG. 25 that includes, among other things, processors 2504, memory/storage 2506, and input/output (I/O) components 2518. A representative hardware layer 2450 is illustrated and may represent, for example, the machine 2500 of FIG. 25. The representative hardware layer 2450 comprises one or more processing units 2452 having associated executable instructions 2454. The executable instructions 2454 represent the executable instructions of the software architecture 2402, including implementation of the methods, modules, and so forth of FIGS. 1-8, 14, and 15. The hardware layer 2450 also includes memory and/or storage modules 2456, which also have the executable instructions 2454. The hardware layer 2450 may also comprise other hardware 2458, which represents any other hardware of the hardware layer 2450, such as the other hardware illustrated as part of the machine 2500.

In the example architecture of FIG. 24, the software architecture 2402 may be conceptualized as a stack of layers where each layer provides particular functionality. For example, the software architecture 2402 may include layers such as an operating system 2420, libraries 2416, frameworks/middleware 2414, applications 2412, and a presentation layer 2410. Operationally, the applications 2412 and/or other components within the layers may invoke application programming interface (API) calls 2404 through the software stack and receive a response, returned values, and so forth illustrated as messages 2408 in response to the API calls 2404. The layers illustrated are representative in nature, and not all software architectures have all layers. For example, some mobile or special-purpose operating systems may not provide a frameworks/middleware 2414 layer, while others may provide such a layer. Other software architectures may include additional or different layers.

The operating system 2420 may manage hardware resources and provide common services. The operating system 2420 may include, for example, a kernel 2418, services 2422, and drivers 2424. The kernel 2418 may act as an abstraction layer between the hardware and the other software layers. For example, the kernel 2418 may be responsible for memory management, processor management (e.g., scheduling), component management, networking, security settings, and so on. The services 2422 may provide other common services for the other software layers. The drivers 2424 may be responsible for controlling or interfacing with the underlying hardware. For instance, the drivers 2424 may include display drivers, camera drivers, Bluetooth®, drivers, flash memory drivers, serial communication drivers (e.g., Universal Serial Bus (USB) drivers), Wi-Fi® drivers, audio drivers, power management drivers, and so forth depending on the hardware configuration.

The libraries 2416 may provide a common infrastructure that may be utilized by the applications 2412 and/or other components and/or layers. The libraries 2416 typically provide functionality that allows other software modules to perform tasks in an easier fashion than by interfacing directly with the underlying operating system 2420 functionality (e.g., kernel 2418, services 2422, and/or drivers 2424). The libraries 2416 may include system libraries 2442 (e.g., C standard library) that may provide functions such as memory allocation functions, string manipulation functions, mathematic functions, and the like. In addition, the libraries 2416 may include API libraries 2444 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 2416 may also include a wide variety of other libraries 2446 to provide many other APIs to the applications 2412 and other software components/modules.

The frameworks 2414 (also sometimes referred to as middleware) may provide a higher-level common infrastructure that may be utilized by the applications 2412 and/or other software components/modules. For example, the frameworks 2414 may provide various graphic user interface (GUI) functions, high-level resource management, high-level location services, and so forth. The frameworks 2414 may provide a broad spectrum of other APIs that may be utilized by the applications 2412 and/or other software components/modules, some of which may be specific to a particular operating system or platform.

The applications 2412 include the talent flow manager 125, the report generator 127, and other modules as shown in FIG. 1, built-in applications 2436, and third-party applications 2438. Examples of representative built-in applications 2436 may include, but are not limited to, a contacts application, a browser application, a book reader application, a location application, a media application, a messaging application, and/or a game application. The third-party applications 2438 may include any of the built-in applications 2436 as well as a broad assortment of other applications. In a specific example, the third-party application 2438 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 2438 may invoke the API calls 2404 provided by the mobile operating system such as the operating system 2420 to facilitate functionality described herein.

The applications 2412 may utilize built-in operating system functions (e.g., kernel 2418, services 2422, and/or drivers 2424), libraries (e.g., system libraries 2442, API libraries 2444, and other libraries 2446), or frameworks/middleware 2414 to create user interfaces to interact with users of the system. Alternatively, or additionally, in some systems, interactions with a user may occur through a presentation layer, such as the presentation layer 2410. In these systems, the application/module “logic” may be separated from the aspects of the application/module that interact with a user.

Some software architectures utilize virtual machines. In the example of FIG. 24, this is illustrated by a virtual machine 2406. A virtual machine creates a software environment where applications/modules may execute as if they were executing on a hardware machine (such as the machine 2500 of FIG. 25, for example). The virtual machine 2406 is hosted by a host operating system (e.g., the operating system 2420 in FIG. 24) and typically, although not always, has a virtual machine monitor 2460, which manages the operation of the virtual machine 2406 as well as the interface with the host operating system (e.g., the operating system 2420). A software architecture executes within the virtual machine 2406, such as an operating system 2434, libraries 2432, frameworks/middleware 2430, applications 2428, and/or a presentation layer 2426. These layers of software architecture executing within the virtual machine 2406 may be the same as corresponding layers previously described or may be different.

FIG. 25 is a block diagram illustrating components of a machine 2500, according to some example embodiments, able to read instructions from a machine-readable medium (e.g., a machine-readable storage medium) and perform any one or more of the methodologies discussed herein. Specifically, FIG. 25 shows a diagrammatic representation of the machine 2500 in the example form of a computer system, within which instructions 2510 (e.g., software, a program, an application, an applet, an app, or other executable code) for causing the machine 2500 to perform any one or more of the methodologies discussed herein may be executed. For example, the instructions 2510 may cause the machine 2500 to execute the flow diagrams of FIGS. 4 and 15. Additionally, or alternatively, the instructions 2510 may implement the programs of the social networking server 112, and so forth. The instructions 2510 transform the general, non-programmed machine 2500 into a particular machine 2510 programmed to carry out the described and illustrated functions in the manner described.

In alternative embodiments, the machine 2500 operates as a standalone device or may be coupled (e.g., networked) to other machines. In a networked deployment, the machine 2500 may operate in the capacity of a server machine or a client machine in a server-client network environment, or as a peer machine in a peer-to-peer (or distributed) network environment. The machine 2500 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2510, sequentially or otherwise, that specify actions to be taken by the machine 2500. Further, while only a single machine 2500 is illustrated, the term “machine” shall also be taken to include a collection of machines 2500 that individually or jointly execute the instructions 2510 to perform any one or more of the methodologies discussed herein.

The machine 2500 may include processors 2504, memory/storage 2506, and I/O components 2518, which may be configured to communicate with each other such as via a bus 2502. In an example embodiment, the processors 2504 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 2508 and a processor 2512 that may execute the instructions 2510. The term “processor” is intended to include multi-core processors that may comprise two or more independent processors (sometimes referred to as “cores”) that may execute instructions contemporaneously. Although FIG. 25 shows multiple processors 2504, the machine 2500 may include a single processor with a single core, a single processor with multiple cores (e.g., a multi-core processor), multiple processors with a single core, multiple processors with multiple cores, or any combination thereof.

The memory/storage 2506 may include a memory 2514, such as a main memory, or other memory storage, and a storage unit 2516, both accessible to the processors 2504 such as via the bus 2502. The storage unit 2516 and memory 2514 store the instructions 2510 embodying any one or more of the methodologies or functions described herein. The instructions 2510 may also reside, completely or partially, within the memory 2514, within the storage unit 2516, within at least one of the processors 2504 (e.g., within the processor's cache memory), or any suitable combination thereof, during execution thereof by the machine 2500. Accordingly, the memory 2514, the storage unit 2516, and the memory of the processors 2504 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store the instructions 2510. The term “machine-readable medium” shall also be taken to include any medium, or combination of multiple media, that is capable of storing instructions (e.g., instructions 2510) for execution by a machine (e.g., machine 2500), such that the instructions, when executed by one or more processors of the machine (e.g., processors 2504), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 2518 may include a wide variety of components to receive input, provide output, produce output, transmit information, exchange information, capture measurements, and so on. The specific I/O components 2518 that are included in a particular machine will depend on the type of machine. For example, portable machines such as mobile phones will likely include a touch input device or other such input mechanisms, while a headless server machine will likely not include such a touch input device. It will be appreciated that the I/O components 2518 may include many other components that are not shown in FIG. 25. The I/O components 2518 are grouped according to functionality merely for simplifying the following discussion, and the grouping is in no way limiting. In various example embodiments, the I/O components 2518 may include output components 2526 and input components 2528. The output components 2526 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 2518 may include biometric components 2530, motion components 2534, environmental components 2536, or position components 2538, among a wide array of other components. For example, the biometric components 2530 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2534 may include acceleration sensor components (e.g., accelerometer), gravitation sensor components, rotation sensor components (e.g., gyroscope), and so forth. The environmental components 2536 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 2538 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2518 may include communication components 2540 operable to couple the machine 2500 to a network 2532 or devices 2520 via a coupling 2524 and a coupling 2522, respectively. For example, the communication components 2540 may include a network interface component or other suitable device to interface with the network 2532. In further examples, the communication components 2540 may include wired communication components, wireless communication components, cellular communication components, Near Field Communication (NFC) components. Bluetooth® components (e.g., Bluetooth® Low Energy), Wi-Fi® components, and other communication components to provide communication via other modalities. The devices 2520 may be another machine or any of a wide variety of peripheral devices (e.g., a peripheral device coupled via a USB).

Moreover, the communication components 2540 may detect identifiers or include components operable to detect identifiers. For example, the communication components 2540 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2540, such as location via Internet Protocol (IP) geo-location, location via Wi-Fi® signal triangulation, location via detecting an NFC beacon signal that may indicate a particular location, and so forth.

In various example embodiments, one or more portions of the network 2532 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network another type of network, or a combination of two or more such networks. For example, the network 2532 or a portion of the network 2532 may include a wireless or cellular network and the coupling 2524 may be a Code Division Multiple Access (CDMA) connection, a Global System for Mobile communications (GSM) connection, or another type of cellular or wireless coupling. In this example, the coupling 2524 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 2510 may be transmitted or received over the network 2532 using a transmission medium via a network interface device (e.g., a network interface component included in the communication components 2540) and utilizing any one of a number of well-known transfer protocols (e.g., hypertext transfer protocol (HTTP)). Similarly, the instructions 2510 may be transmitted or received using a transmission medium via the coupling 2522 (e.g., a peer-to-peer coupling) to the devices 2520. The term “transmission medium” shall be taken to include any intangible medium that is capable of storing, encoding, or carrying the instructions 2510 for execution by the machine 2500, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
determining, by one or more processors, transitions of users of a social network based on user profiles stored in a social network database, each transition comprising a change of employment from a source company to a destination company;
creating, by the one or more processors, a member positions table based on the determined transitions and the user profiles, the member positions table including a first field for a company identifier and a second field for a previous company identifier, wherein the previous company identifier indicates a transition from the source company that is associated with the previous company identifier to the destination company that is associated with the company identifier;
providing, by the one or more processors, a user interface for receiving user input to create a report based on the determined transitions;
accessing, by the one or more processors, the member positions table to generate report data based on the received user input; and
causing, by the one or more processors, presentation of the report based on the report data.

2. The method as recited in claim 1, wherein the member positions table is a member positions table including one row per member position, the member positions table including fields for, at least, a member identifier, the previous company identifier, the company identifier, a title identifier, and a geographic identifier.

3. The method as recited in claim 1, wherein a member profile table includes one row per member profile, the member profile table including fields for, at least, a member identifier, a list of company identifiers, a list of title identifiers, and a list of geographic identifiers.

4. The method as recited in claim 1, wherein creating the member positions table further comprises:
partitioning and sorting the member positions table based on company identifier, wherein information for a given company resides in one server, wherein each server comprises information for one or more companies.

5. The method as recited in claim 1, wherein a first report comprises information for a given a company and tabular and graphic representations of head-to-head comparisons of the given company with other companies for a number of departures and a number of hires.

6. The method as recited in claim 1, wherein a second report comprises information for a given a company including a chart showing a number of departures and a number of hires over time.

7. The method as recited in claim 1, further comprising:
creating a member education table comprising information about education of users, wherein a third report presents information about educational institutions educating users with a given skill.

8. The method as recited in claim 1, further comprising:
creating an employer engagement table with information about interactions of the users of the social network with one or more companies.

9. The method as recited in claim 1, further comprising:
creating a job postings table with information about jobs posted over time on the social network.

10. The method as recited in claim 1, further comprising:
creating a geographic transitions table with information about transitions between different geographic locations.

11. A method comprising:
identifying, by one or more processors, a transition of member of a social network from a source company to a destination company based on a profile of the member, the transition being determined by identifying that employment at the destination company follows employment at the source company;
adding, by the one or more processors, a row to a members position table for the identified transition, the members position table including a row for each position of the members of the social network, the member positions table including a first field for a company identifier and a second field for a previous company identifier, wherein the previous company identifier indicates a transition from the source company that is associated with the previous company identifier to the destination company that is associated with the company identifier;
receiving, by the one or more processors, via a user interface, a request for a report related to user transitions;
querying, by the one or more processors, the member positions table to identify transitions based on a value of the previous company identifier;
generating, by the one or more processors, the report based on a response to the query; and
causing, by the one or more processors, presentation of the report based on the report data.

12. The method as recited in claim 11, wherein the member positions table includes fields for, at least, a member identifier, the previous company identifier, the company identifier, a title identifier, and a geographic identifier.

13. The method as recited in claim 11, wherein a member profile table includes one row per member profile, the member profile table including fields for, at least, a member identifier, a list of company identifiers, a list of title identifiers, and a list of geographic identifiers.

14. The method as recited in claim 11, further comprising:
partitioning and sorting the member positions table based on company identifier, wherein information for a given company resides in one server, wherein each server comprises information for one or more companies.

15. The method as recited in claim 11, wherein the report comprises information for a given a company and tabular and graphic representations of head-to-head comparisons of the given company with other companies for a number of departures and a number of hires.

16. A non-transitory machine-readable storage medium including instructions that, when executed by a machine, cause the machine to perform operations comprising:
determining transitions of users of a social network based on user profiles stored in a social network database, each transition comprising a change of employment from a source company to a destination company;
creating a member positions table based on the determined transitions and the user profiles, the member positions table including a first field for a company identifier and a second field for a previous company identifier, wherein the previous company identifier indicates a transition from the source company that is associated with the previous company identifier to the destination company that is associated with the company identifier;
providing a user interface for receiving user input to create a report based on the determined transitions;
accessing the member positions table to generate report data based on the received user input; and
causing presentation of the report based on the report data.

17. The machine-readable storage medium as recited in claim 16, wherein the member positions table includes one row per member position, the member positions table including fields for, at least, a member identifier, the previous company identifier, the company identifier, a title identifier, and a geographic identifier.

18. The machine-readable storage medium as recited in claim 16, wherein a member profile table includes one row per member profile, the member profile table including fields for, at least, a member identifier, a list of company identifiers, a list of title identifiers, and a list of geographic identifiers.

19. The machine-readable storage medium as recited in claim 16, wherein creating the member positions table further comprises:
partitioning and sorting the member positions table based on company identifier, wherein information for a given company resides in one server, wherein each server comprises information for one or more companies.

20. The machine-readable storage medium as recited in claim 16, wherein a first report comprises information for a given a company and tabular and graphic representations of head-to-head comparisons of the given company with other companies for a number of departures and a number of hires, wherein a second report comprises information for a given a company including a chart showing a number of departures and a number of hires over time.
